(19) United States
(12) Patent Application Publication
(10) Pub. No.: US 2012/0162065 A1
(43) Pub. Date: Jun. 28, 2012

(54) SKELETAL JOINT RECOGNITION AND TRACKING SYSTEM

(75) Inventors: Philip Tossell, Nuneaton (GB); Andrew Wilson, Leics (GB); Alex Aben-Athar Kipman, Redmond, WA (US); Johnny Chung Lee, Bellevue, WA (US); Alex Balan, Redmond, WA (US); Jamie Shotton, Cambridge (GB); Richard Moore, Redmond, WA (US); Oliver Williams, San Francisco, CA (US); Ryan Geiss, San Jose, CA (US); Mark Finocchio, Redmond, WA (US); Kathryn Stone Perez, Kirkland, WA (US); Aaron Kornblum, Mercer Island, WA (US); John Clavin, Seattle, WA (US)

(73) Assignee: MICROSOFT CORPORATION, Redmond, WA (US)

(21) Appl. No.: 13/410,681

(22) Filed: Mar. 2, 2012

Related U.S. Application Data
(63) Continuation of application No. 12/825,657, filed on Jun. 29, 2010.

(51) Int. Cl. G06F 3/01

(52) U.S. Cl. 345/156

(57) ABSTRACT

A system and method are disclosed for recognizing and tracking a user's skeletal joints with a NUI system and further, for recognizing and tracking only some skeletal joints, such as for example a user's upper body. The system may include a limb identification engine which may use various methods to evaluate, identify and track positions of body parts of one or more users in a scene. In examples, further processing efficiency may be achieved by segmenting the field of view in smaller zones, and focusing on one zone at a time. Moreover, each zone may have its own set of predefined gestures which are recognized.

### CLAIM OF PRIORITY

This application is a continuation application of U.S. application Ser. No. 12/825,657, “SKELETAL JOINT RECOGNITION AND TRACKING SYSTEM,” filed on Jun. 29, 2010, Attorney Docket No. MSFT 01397US0, which is incorporated herein by reference in its entirety.

### BACKGROUND

In the past, computing applications such as computer games and multimedia applications used controllers, remotes, keyboards, mice, or the like to allow users to manipulate game characters or other aspects of an application. More recently, computer games and multimedia applications have begun employing cameras and software gesture recognition engines to provide a natural user interface (“NUI”). With NUI, raw joint data and user gestures are detected, interpreted and used to control game characters or other aspects of an application.

NUI applications typically track motion from all of a user's joints, as well as background objects from the entire field of view. However, at times a user may be interacting with a NUI application using only a portion of his or her body. For example, a user may be resting in a chair or in a wheelchair without use of his or her legs. In these instances, the NUI application still tracks a user's lower body.

### SUMMARY

Disclosed herein are systems and methods for recognizing and tracking a user's skeletal joints with a NUI system and, in embodiments, for recognizing and tracking only some skeletal joints, such as for example a user's upper body. The system may include a limb identification engine which receives frame data of a field of view from an image capture device. The limb identification engine may then use various methods including Exemplar and centroid generation, magnetism and a variety of scored tests to evaluate, identify and track positions of a head, shoulders and other body parts of one or more users in a scene.

In embodiments, the present system includes a capture device for capturing a color image and/or a depth image of one or more players (also called users herein) in a field of view. Given a color and/or depth image, or image sequence, in which one or more players are in motion, a common end goal of a human-tracking system such as that of the present technology is to analyze the image(s) and to robustly determine where the people are in the scene, including the locations of their body parts.

A system to solve such a problem can be broken down into two sub-problems: identifying multiple candidate body part locations, and then reconciling them into whole or partial skeletons. Embodiments of the limb identification engine include a body part proposal system for identifying multiple candidate body part locations, and a skeleton resolution system for reconciling the candidate body parts into whole or partial skeletons.

The body part proposal system may consume image(s) and produce a set of candidate body part locations (with potentially many candidates for each body part) throughout the scene. These body part proposal systems can be stateless or stateful. A stateless system is one which produces candidate body part locations without reference to prior states (prior frames). A stateful system is one which produces candidate body part location with reference to prior states, or prior frames. An example of stateless body part proposal systems includes Exemplar plus centroids for identifying candidate body parts. The present technology further discloses a stateful system referred to herein as magnetism for identifying candidate body parts. The body part proposal system by nature may often produce many false positives. Therefore, the limb identification engine further includes the skeleton resolution system for reconciling the candidate body parts and distinguishing the false positives from the correctly identified bodies and/or body parts within the field of view.

The skeleton resolution system consumes the body part proposals from one or more body part proposal systems, potentially including many false positives, and reconciles the data into whole, robust skeletons. In one embodiment, the skeleton resolution system works by connecting the body part proposals in various ways to produce a large number of (partial or whole) skeletal hypotheses. In order to reduce computational complexity, certain parts of a skeleton (such as the head and shoulders) might be resolved first, followed by others (such as the arms). These hypotheses are then scored in various ways, and the scores and other information are used to select the best hypotheses and reconcile where the players actually are.

Hypotheses are scored using many robust cost functions. Body part proposals and skeletal hypotheses scoring higher in the cost functions are more likely to be correctly identified body parts. Some of these cost functions are high-level, in that they may be performed initially to remove several skeletal hypotheses at a high level. Such tests in accordance with the present system include whether or not a given skeletal hypothesis is kinematically valid (i.e., possible). Other high level tests in accordance with the present system include joint rotation tests, which test whether the rotation of one or more joints in a skeletal hypothesis have passed the joint rotation limits for the expected body parts.

Other cost functions are more low-level, and are performed on each body part proposal within a skeletal hypothesis, across all skeletal hypotheses. One such cost function in accordance with the present system is the trace and saliency test which examines depth values of trace samples within one or more body part proposals and saliency samples outside of one or more body part proposals. The samples that have depth values as expected score higher under this test. A further cost function in accordance with the present system is a pixel motion detection test, which tests for determining if a body part (such as a hand) is in motion. Detected pixel motion in the x, y and/or z direction in key areas of a hypothesis can increase the score of the hypothesis.

In addition, a hand refinement technique is described that, in conjunction with the skeleton resolution system, produces extremely robust refined hand positions.

In further embodiments of the present technology, further processing efficiency may be achieved by segmenting the field of view into smaller zones, and focusing on one zone at a time. Moreover, each zone may have its own set of predefined gestures which are recognized and which varies from zone to zone. This avoids the possibility of receiving and processing conflicting gestures within a zone, and further simplifies and speeds processing rates.

In one example, the present technology relates to a method of gesture recognition, including the steps of: a) receiving position information from a user in the scene, the user having a first body part and second body part; b) recognizing a gesture from the first body part; c) ignoring a gesture performed by the second body part; and d) performing an action associated with the gesture from the first body part recognized in said step b).

In a further example, the present technology relates to a method of recognizing and tracking body parts of a user, including the steps of: a) receiving position information from a user in the scene; b) identifying a first group of joints of the user from the position information received in said step a); c) ignoring a second group of joints of the user; d) identifying positions of joints in the first group of joints; and e) performing an action based on positions of the joints identified in said step d).

Another example of the present technology relates to a computer-readable storage medium capable of programming a processor to perform a method of recognizing and tracking body parts of a user having at least limited use of at least one immobilized body part. The method includes the steps of: a) receiving an indication from the user of the identity of the at least one immobilized body part; b) identifying a first group of joints of the user, the joints not included within the at least one immobilized body part; c) identifying positions of joints in the first group of joints; and d) performing an action based on positions of the joints identified in said step c).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A illustrates an example embodiment of a target recognition, analysis, and tracking system.

FIG. 1B illustrates a further example embodiment of a target recognition, analysis, and tracking system.

FIG. 1C illustrates a further example embodiment of a target recognition, analysis, and tracking system.

FIG. 2 illustrates an example embodiment of a capture device that may be used in a target recognition, analysis, and tracking system.

FIG. 3 is a high level flowchart of a system for modeling and tracking joints in the upper body via a natural user interface according to embodiments of the present technology.

FIGS. 4A and 4B are a detailed flowchart of a system for modeling and tracking joints in the upper body via a natural user interface according to embodiments of the present technology.

FIGS. 5A and 5B are a flowchart of step 308 in FIG. 4A for generating head and shoulder triangles for modeling and tracking joints in the upper body via a natural user interface according to embodiments of the present technology.

FIG. 6 is a flowchart of step 368 of FIG. 5A showing factors used in scoring head and shoulder triangles generated in FIG. 5.

FIG. 7 is a flowchart of step 312 of FIG. 4A illustrating the scoring factors used in evaluating hand positions in FIGS. 4A, 4B.

FIG. 8 is a flowchart of step 318 of FIG. 4A illustrating the scoring factors used in evaluating elbow positions in FIGS. 4A, 4B.

FIG. 9 is an illustration of a user and head triangle generated in embodiments of the present technology.

FIG. 10 is an illustration of a user and trace and saliency sampling points for the head and shoulders.

FIG. 11 is an illustration of a user and trace and saliency sampling points for a user's upper arm, lower arm and hand.

FIG. 12 illustrates skeletal joint positions returned in accordance with the present technology for a user's head, shoulders, elbows, wrists and hands.

FIGS. 13A and 13B illustrate embodiments of a zone-based system of sampling pixels in a field of view according to embodiments of the present technology.

FIG. 14 is a block diagram showing a gesture recognition engine for recognizing gestures.

FIG. 15 is a flowchart of the operation of the gesture recognition engine of FIG. 14.

FIG. 16 is a flowchart of a method for a user to control the leg movements of an on-screen avatar via the user's real world hand movements and gestures.

FIG. 17A illustrates an example embodiment of a computing environment that may be used to interpret one or more gestures in a target recognition, analysis, and tracking system.

FIG. 17B illustrates another example embodiment of a computing environment that may be used to interpret one or more gestures in a target recognition, analysis, and tracking system.

### DETAILED DESCRIPTION

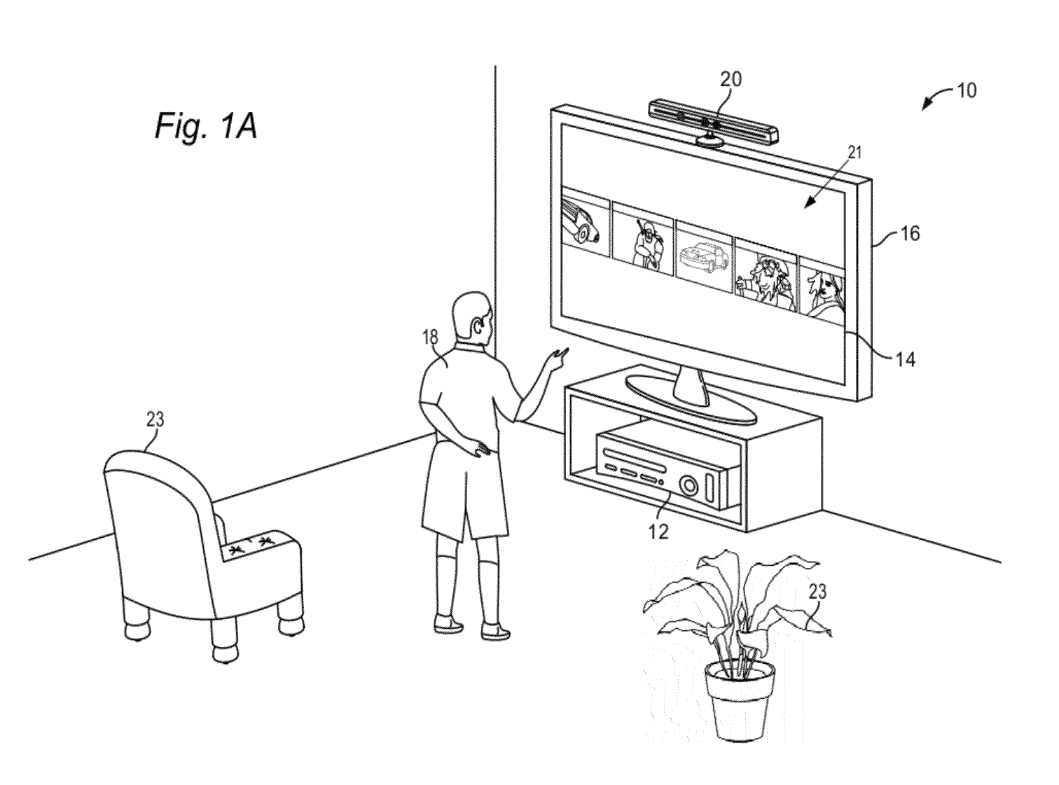

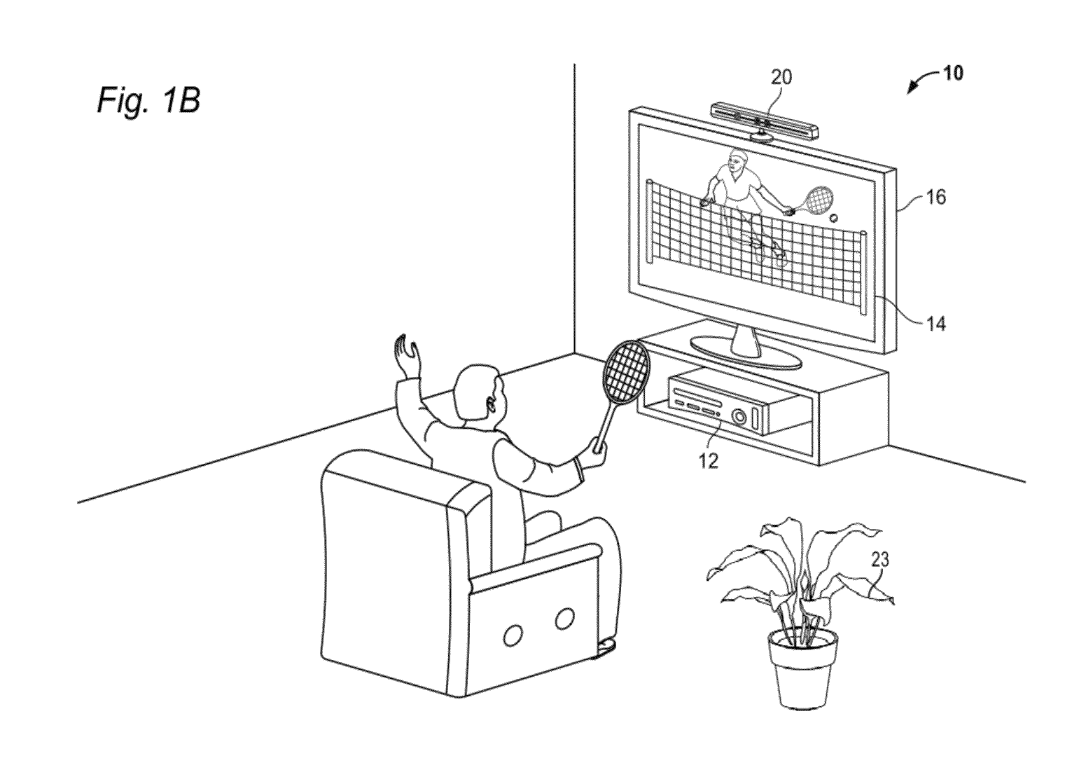

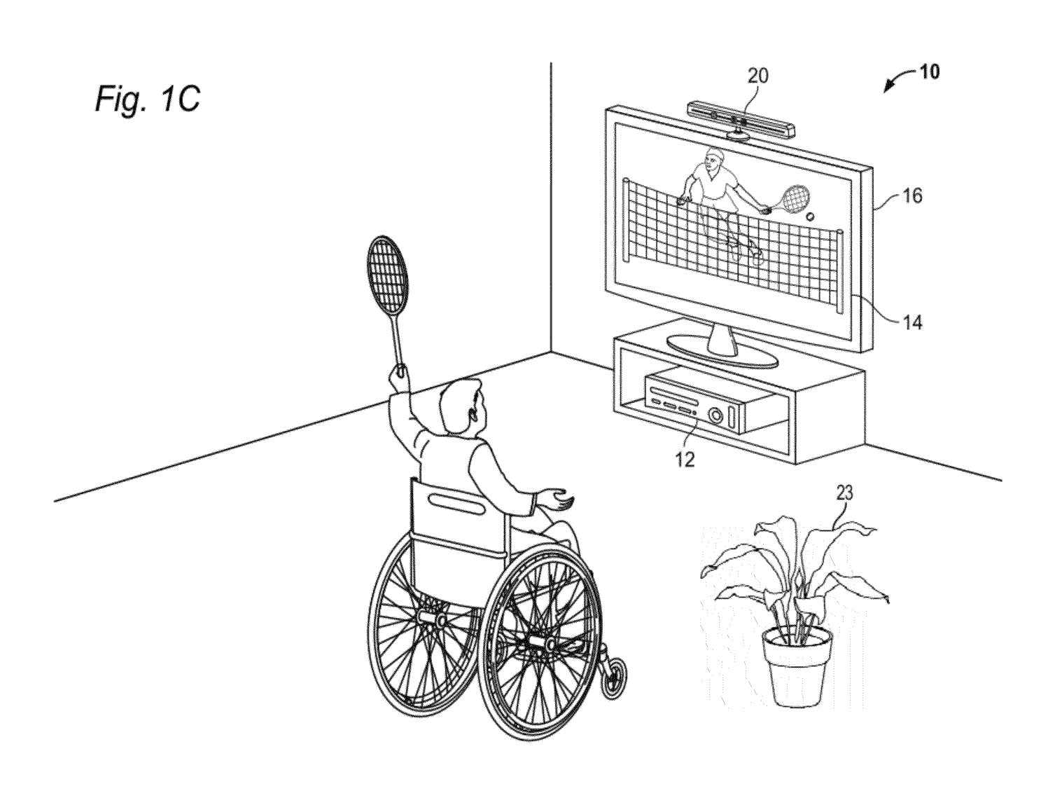

Embodiments of the present technology will now be described with reference to FIGS. 1A-17B, which in general relate to a system and method for recognizing and tracking a user's skeletal joints with a NUI system and, in embodiments, for recognizing and tracking only some skeletal joints, such as for example a user's upper body. The system may include a limb identification engine which receives frame data of a field of view (FOV) from an image capture device. In general, embodiments of the limb identification engine include a body part proposal system for identifying multiple candidate body part locations, and a skeleton resolution system for reconciling the candidate body parts into whole or partial skeletons.

The body part proposal system may then use Exemplar and centroid generation methods to identify body parts within the FOV with some associated confidence level. The system may also make use of magnetism, which estimates the new positions of body parts whose positions were known in the previous frame, by “snapping” them to nearby features in the image data for the new frame. Exemplar and centroid generation methods are explained in further detail in U.S. patent application Ser. No. 12/770,394, entitled “Multiple Centroid Condensation of Probability Distribution Clouds,” which application is incorporated by reference herein in its entirety. However, it is understood that Exemplar and centroid generation is just one method which can be used to identify candidate body parts. Other algorithms could be used instead of, or in addition to, Exemplar and/or centroids which analyze an image and can output various candidate joint positions for various body parts (with or without probabilities).

Where Exemplar and centroid generation techniques are used, these techniques identify candidate body part locations. The identified positions may be correct or incorrect. It is one goal of the present system to fuse candidate body part locations together into a coherent picture of where the people are in the scene, and what pose they are in. In embodiments, the limb identification engine may further include a skeleton resolution system for this purpose.

In embodiments, the skeleton resolution system may identify upper body joints such as a head, shoulders, elbows, wrists and hands for each frame of data captured. In such embodiments, the limb identification engine may use Exemplar and a variety of scoring subroutines to identify centroid groupings that correspond to a user's shoulders and head. These centroid groupings are referred to herein as head triangles. Using hand proposals from a variety of sources, including but not limited to magnetism, centroids from Exemplar, or other components, the skeleton resolution system of the limb identification engine may further identify potential hand locations, or hand proposals, of the hands of users within the FOV. The skeleton resolution system may next evaluate a number of elbow positions for each hand proposal. From these operations, the skeleton resolution system of the limb identification engine may identify head, shoulder and arm positions for each player for each frame.

Focusing on only a fraction of a user's body joints, the present system is able to process image data more efficiently than in systems which measure all body joints. To further aid in processing efficiency, a capture device capturing image data may segment the field of view in smaller zones. In such embodiments, the capture device may focus exclusively on a single zone, or cycle through the smaller zones in successive frames. There may be other advantages beyond processing efficiency to focusing on select body joints or zones. Focus on a particular set of joints or zones may further be done to avoid the possibility of receiving and processing conflicting gestures.

Once joint positions for the selected joints have been output, this information may be used for a variety of purposes. It may be used for gesture recognition (for gestures made by the captured body parts), as well as interaction with virtual objects presented by a NUI application. In further embodiments, where for example a user does not have use of their legs, a user may interact with a NUI application in a “leg control mode,” where movements of a user's hands are translated into image data for controlling movement of an onscreen character's legs. These embodiments are explained in greater detail below.

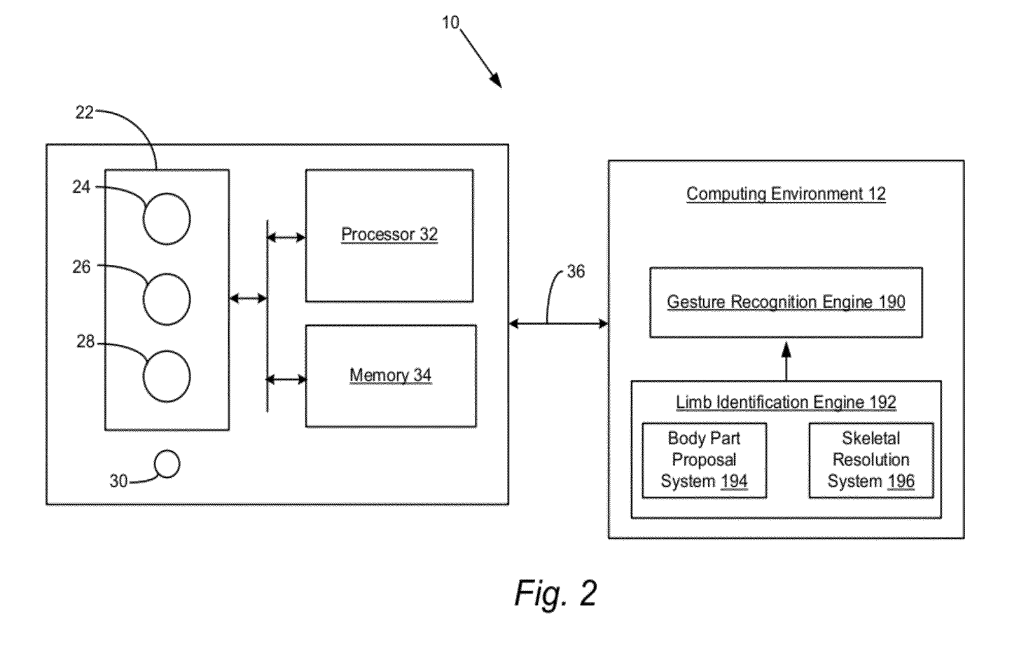

Referring initially to FIGS. 1A-2, the hardware for implementing the present technology includes a target recognition, analysis, and tracking system 10 which may be used to recognize, analyze, and/or track a human target such as the user 18. Embodiments of the target recognition, analysis, and tracking system 10 include a computing environment 12 for executing a gaming or other application. The computing environment 12 may include hardware components and/or software components such that computing environment 12 may be used to execute applications such as gaming and non-gaming applications. In one embodiment, computing environment 12 may include a processor such as a standardized processor, a specialized processor, a microprocessor, or the like that may execute instructions stored on a processor readable storage device for performing processes described herein.

The system 10 further includes a capture device 20 for capturing image and audio data relating to one or more users and/or objects sensed by the capture device. In embodiments, the capture device 20 may be used to capture information relating to partial or full body movements, gestures and speech of one or more users, which information is received by the computing environment and used to render, interact with and/or control aspects of a gaming or other application. Examples of the computing environment 12 and capture device 20 are explained in greater detail below.

Embodiments of the target recognition, analysis and tracking system 10 may be connected to an audio/visual (A/V) device 16 having a display 14. The device 16 may for example be a television, a monitor, a high-definition television (HDTV), or the like that may provide game or application visuals and/or audio to a user. For example, the computing environment 12 may include a video adapter such as a graphics card and/or an audio adapter such as a sound card that may provide audio/visual signals associated with the game or other application. The A/V device 16 may receive the audio/visual signals from the computing environment 12 and may then output the game or application visuals and/or audio associated with the audio/visual signals to the user 18. According to one embodiment, the audio/visual device 16 may be connected to the computing environment 12 via, for example, an S-Video cable, a coaxial cable, an HDMI cable, a DVI cable, a VGA cable, a component video cable, or the like.

In embodiments, the computing environment 12, the A/V device 16 and the capture device 20 may cooperate to render an avatar or on-screen character 19 on display 14.

In embodiments, the avatar 19 mimics the movements of the user 18 in real world space so that the user 18 may perform movements and gestures which control the movements and actions of the avatar 19 on the display 14. As explained below, one aspect of the present technology allows a user to move one set of limbs, for example their arms, to control the movements of different limbs, for example the legs, of an onscreen avatar 19.

In FIG. 1A, the capture device 20 is used in a NUI system where for example a user 18 is scrolling through and controlling a user interface 21 with a variety of menu options presented on the display 14. In FIG. 1A, the computing environment 12 and the capture device 20 may be used to recognize and analyze movements and gestures of a user's upper body, and such movements and gestures may be interpreted as controls for the user interface. In such an embodiment, only the user's upper body may be tracked for movements as explained below.

FIG. 1B shows a further embodiment where a user 18 is playing a tennis gaming application while seated in a chair 23. FIG. 1B shows a similar embodiment, but in this embodiment, a user may be differently-abled having use of less than all of his limbs. In FIG. 1B, the user is in a wheelchair having no use of his legs. In FIGS. 1B and 1C, the computing environment 12 and the capture device 20 may be used to recognize and analyze movements and gestures of a user's upper body, and such movements and gestures may be interpreted as a game control or action affecting action of an avatar 19 in game space.

The embodiments of FIGS. 1A-1C are two of many different applications which may be run on computing environment 12, and the application running on computing environment 12 may be a variety of other gaming and non-gaming applications.

FIGS. 1A-1C include static, background objects 23, such as the chair and plant. These are objects within the scene (i.e., the area captured by capture device 20), but do not change from frame to frame. In addition to the chair and plant shown, static objects may be any objects picked up by the image cameras in capture device 20. The additional static objects within the scene may include any walls, floor, ceiling, windows, doors, wall decorations, etc.

Suitable examples of a system 10 and components thereof are found in the following co-pending patent applications, all of which are hereby specifically incorporated by reference: U.S. patent application Ser. No. 12/475,094, entitled “Environment And/Or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; U.S. patent application Ser. No. 12/391,150, entitled “Standard Gestures,” filed Feb. 23, 2009; and U.S. patent application Ser. No. 12/474,655, entitled “Gesture Tool,” filed May 29, 2009.

FIG. 2 illustrates an example embodiment of the capture device 20 that may be used in the target recognition, analysis, and tracking system 10. In an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight. X and Y axes may be defined as being perpendicular to the Z axis. The Y axis may be vertical and the X axis may be horizontal. Together, the X, Y and Z axes define the 3-D real world space captured by capture device 20.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as a grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

According to another embodiment, the capture device 20 may include two or more physically separated cameras that may view a scene from different angles, to obtain visual stereo data that may be resolved to generate depth information. In another example embodiment, the capture device 20 may use point cloud data and target digitization techniques to detect features of the user.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 32. According to another embodiment, the memory component 34 may be integrated into the processor 32 and/or the image camera component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28. With the aid of these devices, a partial skeletal model may be developed in accordance with the present technology, with the resulting data provided to the computing environment 12 via the communication link 36.

The computing environment 12 may further include a limb identification engine 192 having a body part proposal system 194 for proposing candidate body parts, and a skeletal resolution system 196 for reconciling the candidate body parts into whole or partial skeletons. The limb identification engine 192 including the body part proposal system 194 and skeletal resolution system 196 may be partially or wholly run within the capture device 20 in further embodiments. Further details of the limb identification engine 192 including the body part proposal system 194 and skeletal resolution system 196 are set forth below.

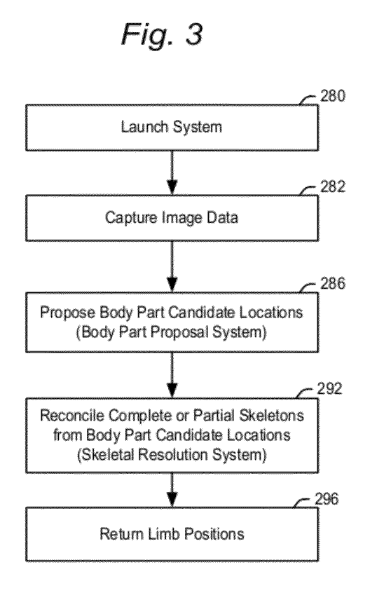

Operation of embodiments of the present technology will now be described with reference to the high level flowchart of FIG. 3. In step 280, the system 10 is launched. In step 282, capture device 20 captures image data. In step 286, the body part proposal system 194 proposes candidate body part locations. In one of several possible embodiments, the body part proposal system runs Exemplar and generates centroids. Exemplar and centroid generation are known techniques for receiving a two-dimensional depth texture image and generating probabilities as to the proper identification of specific body parts within the image. In embodiments, centroids are generated for a user's head, shoulders, elbows, wrists and hands as explained below. However, it is understood that centroids may be generated for lower body part joints, the entire body, or selected joints in further embodiments. Again, it is noted that Exemplar and centroid generation are just one example for identifying body parts in an image, and it is understood that any of a wide variety of other methods may be used for this purpose. Other stateless techniques may be used. In further embodiments, stateful techniques, including for example magnetism, may additionally be used as explained below.

The body part proposal system step 286 may be performed by a graphics processing unit (GPU) in either the capture device 20 or computing environment 12. Portions of this step may be performed by a central processing unit (CPU) in capture device 20 for computing environment 12, or by dedicated hardware, in further embodiments.

In step 292, the skeletal resolution system 196 may identify and track joints in the upper body as described below. In step 296, the skeletal resolution system 196 returns identified limb positions for use in controlling the computing environment 12 or an application running on the computing environment 12. In embodiments, the skeletal resolution system 196 of the limb identification engine 192 may return information on a user's head, shoulders, elbows, wrists and hands. In further embodiments, the returned information may include only some of those joints, additional joints such as joints from the lower body or the left or right side of the body, or all body joints.

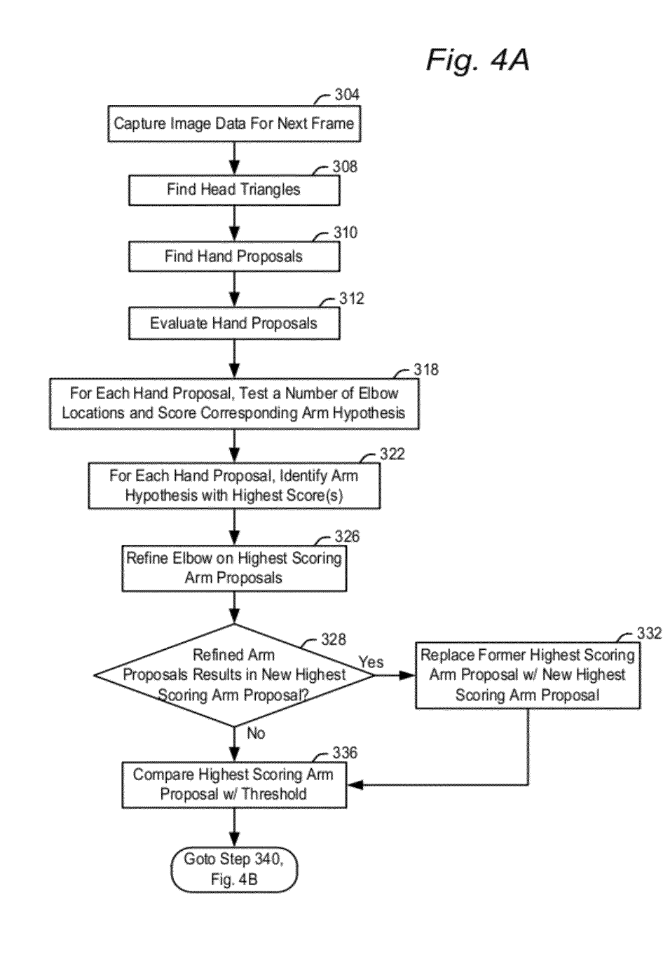

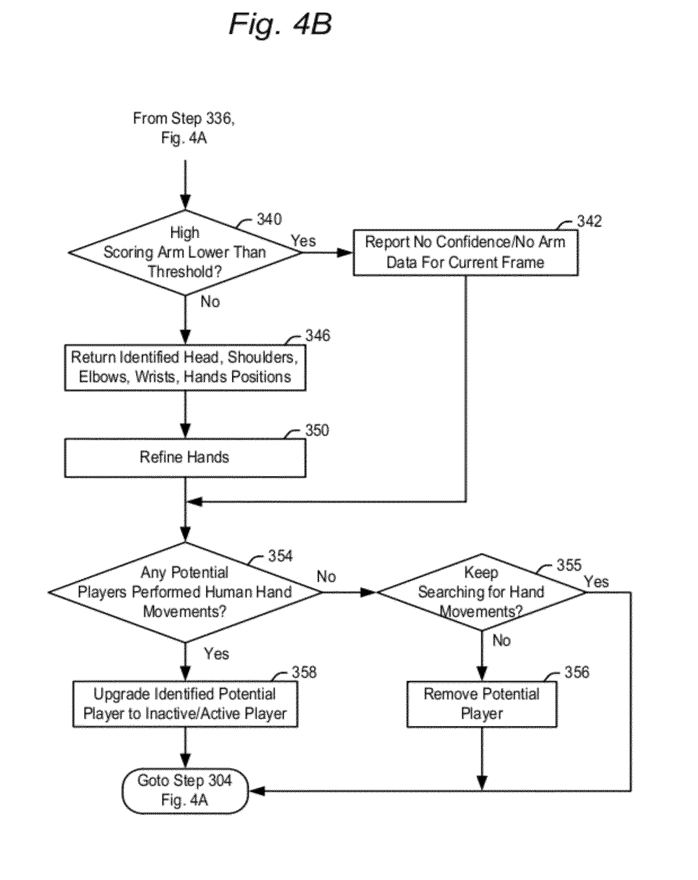

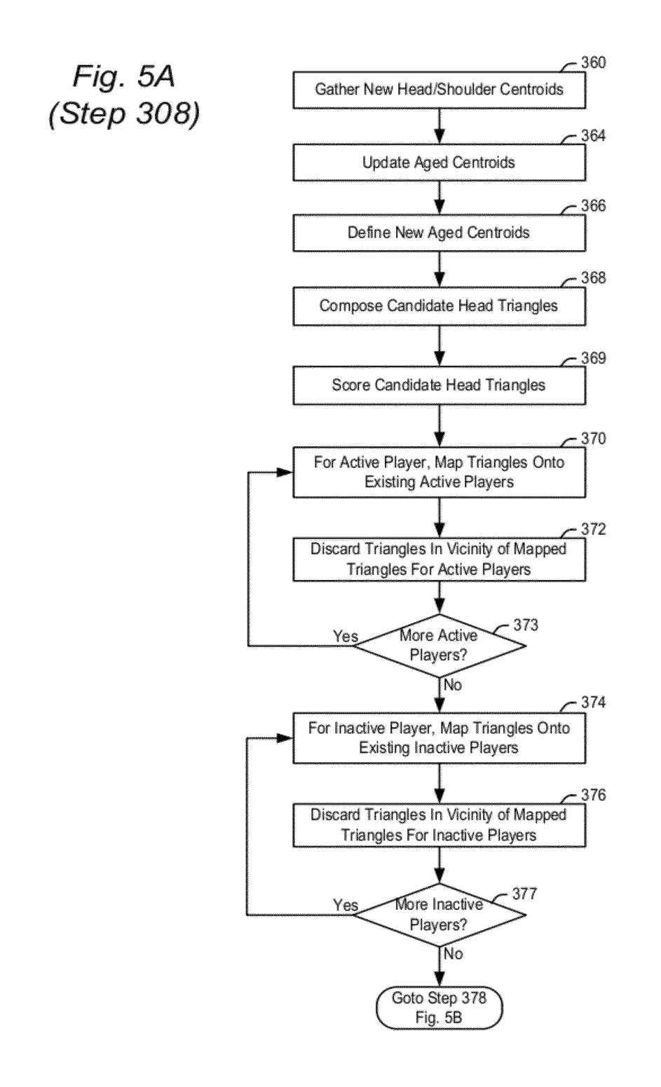

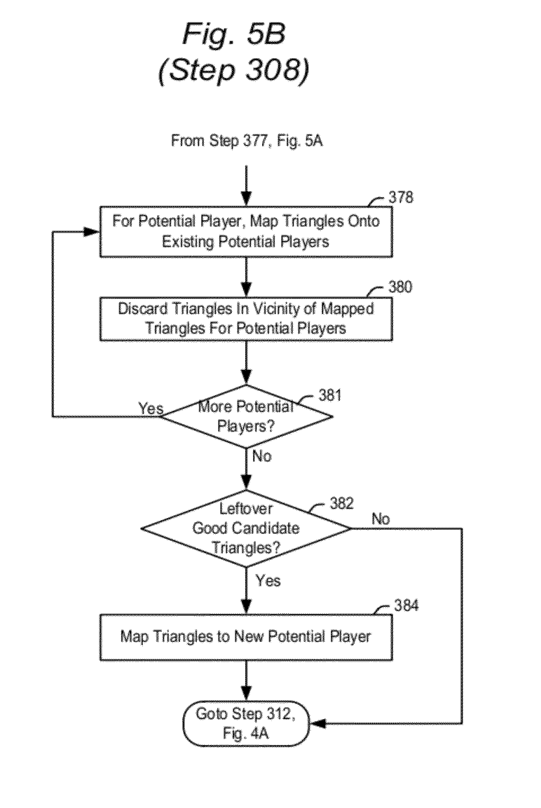

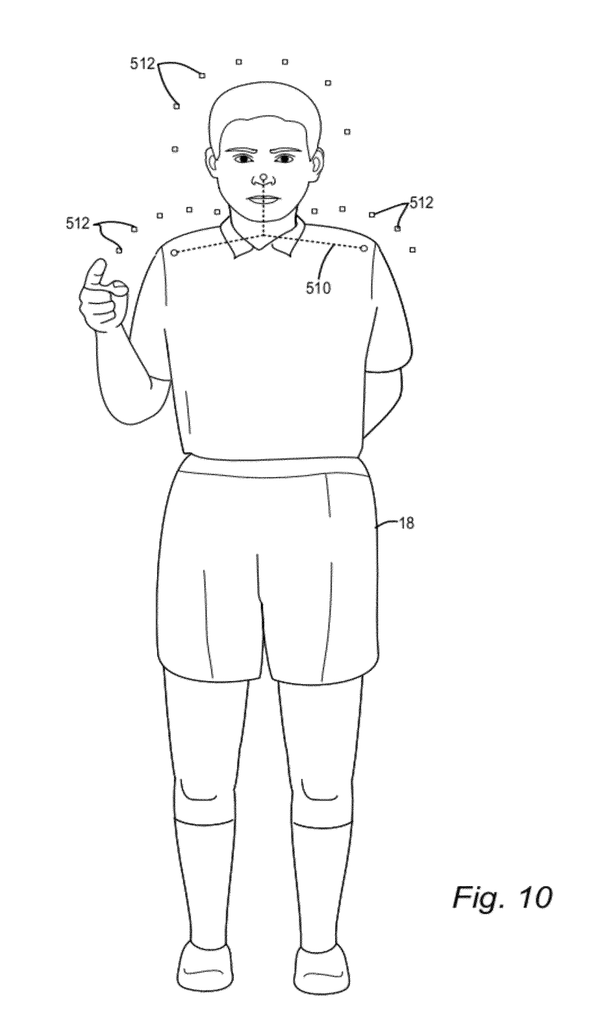

A more detailed explanation of the body part proposal system 194 and the skeletal resolution system 196 of the limb identification engine 192 will now be explained with reference to the flowchart of FIGS. 4A and 4B. In general, the limb identification engine 192 identifies head, shoulders and limbs, as well as potentially other body parts in other embodiments. The engine 192 consumes centroids (or candidate body part locations from other body part proposal systems) and depth map data, and returns positions of player joint locations with a corresponding confidence. In step 304, capture device 20 captures image data of the FOV for the next frame. In embodiments, the frame rate may be 30 Hz, though the frame rate may be higher or lower than that in further embodiments. In step 308, the limb identification engine 192 first finds head triangles. In general, candidate head triangles may be formed from one head centroid connected to two shoulder centroids from the group of head and shoulder centroids identified by Exemplar from the image data. FIG. 10 shows an example of a head triangle 500 formed from candidate centroids 502, 504 and 506. A more detailed explanation of step 308 for finding head triangles is now explained with reference to the flowchart of FIGS. 5A and 5B.

In general, Exemplar provides strong head and shoulder signals for users, and this signal becomes stronger when patterns of one head and two shoulder centroids may be found together. Head centroids may come from any number of sources other than Exemplar/centroids, including for example head magnetism and simple pattern matching. In step 360, the limb identification engine 192 gathers new head and shoulder centroids in the most recent frame. The new head and shoulder centroids are used to update existing, or “aged” centroids which were found in previous frames. Occlusions may exist so that not all centroids are seen in each frame. Aged centroids are used to carry over knowledge of candidate body part locations from the previous processing of a given zone. In step 364, the new head and shoulder centroids are used to update aged centroids in that any new centroids found which are nearby to aged centroids may be merged into the existing aged centroids. Any new centroids which are not near to an aged centroid are added as new aged centroids in step 366. The aged and new centroids may result in multiple candidate head triangles.

In step 368, the head triangles may be composed. Where the head and shoulders are visible, a head triangle may be composed from one or more of the above-described sources. However, it may happen that one or more joints of a user are occluded, such as for example where one player is standing in front of another player. When one or more of the head or shoulder joints is briefly occluded, there might not be a new centroid there (from the new depth map). As a result, the aged centroid that marked its location might or might not be updated. As a result, that aged centroid might do one of two things.

First, an aged centroid may persist, with its location unchanged (waiting for the occlusion to end). Second, an aged centroid may mistakenly jump to a new nearby location (for example, the left shoulder has been occluded, but the upper left edge of the couch looks like a shoulder, and being fairly close, the aged centroid jumps there). In order to cover these cases, extra candidate triangles may be constructed that ignore the aged centroids for one or more of the vertices of the triangle. It is not known which of the three joints are occluded, so many possible triangles may be submitted for evaluation as described below.

In some instances, one joint may be occluded. For example, the left shoulder may be occluded but the head and right shoulder are visible (although again, it is not yet known that it is the left shoulder which is occluded). The head and right shoulder may also have moved, for example to the right by an average of 3 mm. In this case, an extra candidate triangle would be constructed with the left shoulder also moving to the right by 3 mm (rather than dragging where it was, or mistakenly jumping to a new place), so that the triangle shape is preserved (especially over time), even though one of the joints is not visible for some time.

In another example, the head is occluded, for example by another player's hand, but the shoulders are both visible. In this case, if the shoulders move, then an extra candidate triangle would be created using the new shoulder positions, but with the head displaced by the same average displacement of the shoulders.

In some instances two joints may be occluded. Where only one of three joints is visible, then the other two can “drag along” as described above (i.e., move the same direction and magnitude as the single visible joint.

If none of the three joints are visible (all three are occluded), then a spare candidate triangle can be created which just stays in place. This is helpful when one player walks in front of another, entirely occluding the rear player; the rear player's head triangle is allowed to float, in place, for some amount of time, before it is discarded. For example, it may stay in place for 8 seconds, though it may be kept longer or shorter than that in further embodiments. On the other hand, if the occlusion ends before that time runs out, the triangle will be in the correct place, and can snap back on to the rear player. This is sometimes more desireable than re-discovering the rear player as a ‘new’ player, because the identity of the player is maintained.

A scoring subroutine referred to as head triangle trace and saliency is described below for evaluating head triangles. This subroutine tests sample points (including their expected depth, or Z, values) against the depth values at the same pixel (X,Y) location in the image, and is designed so that it will select the triangle that best fits the depth map, among the triangles proposed, even if that triangle happens to be mostly (or even entirely) occluded. Including the extra triangles as described above ensures that the correct triangle is proposed, even if the aged centroids are briefly incorrect, missing, etc.

In step 369, the head triangles may be evaluated by scored subroutines. The goal of the limb identification engine in step 368 is to identify head triangles of aged centroids that are in fact correct indicators of the head and shoulders of the one or more users in the FOV. The limb identification engine 192 will start by producing many triangles by connecting a head aged centroid with left and right shoulder aged centroids. Each of these forms a candidate head triangle. These may or may not be the head and shoulders of a given user. Each of these candidate head triangles are then evaluated by performing a number of scored subroutines.

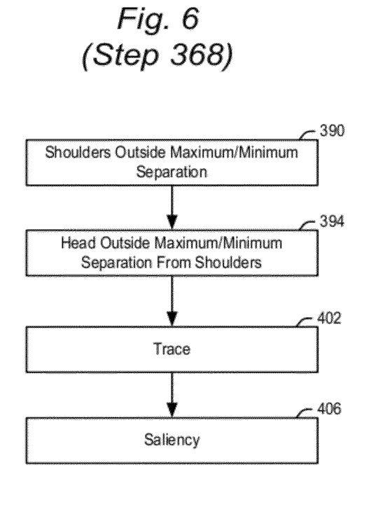

The scored subroutines are run on the candidate head triangles to identify the best (i.e., the highest scored) head triangles. Further details of the scored subroutines in step 368 are explained in greater detail now with respect to the flowchart of FIG. 6. In step 390, a first scoring subroutine may measure whether the distance between two shoulder centroids in a candidate triangle is below a minimum separation, or exceeds a maximum separation, between left and right shoulders. For example, it is known that humans have a maximum shoulder width between left and right shoulders of approximately 80 cm. The present system may add an additional buffer to that. If two candidate shoulder centroids exceed that maximum, that candidate triangle is removed as a candidate.

Another scored subroutine may measure whether the head is below a minimum separation, or exceeds a maximum separation, above a line between the shoulders in step 394. Again, this dimension may have a known maximum and minimum. The present system may add some additional buffer to that. If a candidate head triangle exceeds that maximum or is below the minimum, that candidate may be excluded.

Other examples of scoring routines similar to steps 390 and 394 include the following. Shoulder-center to head-center vector direction: as the vector from the shoulder-center to head-center is pointed in unfavorable directions (such as down), this can result in penalties to the triangle's score, or (if egregious) result in the triangle being discarded. Vector between left and right shoulders: as the vector between the left and right shoulders is pointed in unfavorable directions (such as opposite what is expected), this can result in penalties to the triangle's score, or (if egregious) result in the triangle being discarded. Differences in the distances from head to left/right shoulders: as the two distances from the head, to either shoulder, become increasingly different, this can result in penalties to the triangle's score, or (if egregious) result in the triangle being discarded. Average distance between aged centroids: if the average distance between the 3 aged centroids (or in other words, the head triangle edge lengths) is very small or very large, this can result in penalties to the triangle's score, or (if egregious) result in the triangle being discarded. In this or any of the above subroutines, if a candidate triangle is discarded as result of a subroutine score, there is no need to perform further subroutine testing on that candidate. Other scoring subroutines may be used.

A significant scored subroutine in scoring candidate head triangles is the trace and saliency steps 402 and 406. Trace step 402 involves taking trace samples along three lines, each starting at the center of the line between shoulders in a candidate head triangle and going out to the three tips of the triangle. For example, FIG. 10 shows head sample traces 510 on the user 18. The pixels are measured along the trace samples 510 and a candidate head triangle is penalized if the depth value is not as expected (i.e., representative of the user's depth in the 3-D real world as indicated by the depth data from image camera component 22).

While the above example of trace samples involves samples lying along lines between joints, the trace samples may be any samples that should fall within the body for a large variety of users, and which evenly occupy the interior space. In embodiments, the samples may fill in a minimum silhouette of a person. In embodiments, the layout of these samples can change drastically depending on the orientation of the candidate head triangle, or other candidate features.

For trace samples, good Z-matches (where the expected depth value and the actual depth value at that screen X,Y location are similar) result in rewards, and bad z-matches result in penalties. The closeness of the match/severity of the mismatch can affect the amount of penalty/reward, and positive vs. negative mismatches may be scored differently. For matches, a close match will score higher than a weak match. Drastic mismatches are treated differently based on the sign of the difference: if the depth map sample is further than expected, this is a ‘salient’ sample and incurs a harsh penalty. If the depth map sample is closer than expected, this is an ‘occlusion’ sample and incurs a mild penalty. In some embodiments, the expected Z values are simply interpolated between the depths of the candidate body part locations. In other embodiments, the expected Z values are adjusted to compensate for common non-linear body shapes, such as the protrusion of the chin and face, relative to the neck and shoulders. In other embodiments, which begin with other parts of the skeleton, similar interpolation and adjustment of the expected Z values can be made.

The saliency subroutine in step 406 operates by defining a number of saliency samples (512 in FIG. 10) at a distance around each of the three points in a given candidate head triangle. In some embodiments, these samples might take the shape of arcs above the points of the triangle. As the size of a user may vary, the saliency samples 512 formed around the shoulders must be formed at a large enough radius so as to ensure that they lie outside the shoulders of even the largest (i.e., bulkiest) possible user, sometimes relative to the size of the head triangle or other candidate feature. This size adjustment might be applied to a lesser degree for the radius of samples around the head, based on the observation that children's heads are proportionally larger than adults' heads. Nevertheless, the saliency samples 512 are positioned around the candidate triangle's head location at a distance so as to ensure they are outside the largest head possible for a user. For a high-scoring candidate head triangle, in contrast to the trace samples 510, the depth value of all saliency samples 512 should be deeper (i.e., further away in the Z direction) than the user 18.

For saliency samples, good Z-matches result in penalties, bad z-matches result in rewards, and positive vs. negative mismatches may be scored differently. If the depth map value is near the expected value, this incurs a penalty. If the depth map value is further than expected, this is a ‘salient’ sample and incurs a reward. And if the depth map value is closer than expected, this is an ‘occlusion’ sample and incurs a mild penalty.

The scores of the various subroutines in steps 390 to 406 are summed to provide the top scoring head triangles. Some of the scoring subroutines may weigh more heavily in this sum than others, such as for example, the trace and saliency tests of steps 402 and 406. It is understood that the different scoring subroutines may have different weights in further embodiments. Moreover, other scoring subroutines may be used in addition to, or instead of, the scoring subroutines shown in FIG. 6 for evaluating whether candidate head triangles do in fact represent the head and shoulders of users in the FOV.

Returning now to FIG. 5A, once the top scoring candidate head triangles are identified, those triangles are mapped onto existing “active,” “inactive” and “potential” users. In particular, users in a field of view which have already been positively identified as people (as opposed to a chair or mannequin) are classified as either active or inactive users. The system distinguishes between potential users and objects which might look human by detecting hand movements over time. In embodiments, given processing constraints, the present system may only track the hand movements (described below) of two users in the field of view. In such embodiments, the two active players may be selected based on any number of criteria, such as which potential players were the first to be validated as human, through human-like hand movements. As an alternative, the active players may be selected (from among the set of active and inactive players) by another component in the system, such as the final consumer of the reconciled skeletal data. The remaining identified users are inactive users. The hand movements of active users are tracked, while the hand movements of inactive users are not. In further embodiments, more than two users, or all users, may be considered active so that their hand movements are tracked.

It may also happen that the depth camera has detected an image which appears, as a result of processing by the limb ID engine, to contain in the field of view, a new person not previously identified. The user indicated in this case is said to be a potential user. The hand movements for potential users may be tracked over a number of frames until they can be positively identified as a person. At that point, the state switches from potential user to either an active or inactive user.

In step 370, for each active player, the top candidate triangles are mapped onto existing active players. Triangles may be mapped to an active player in the field of view based on the active player's previous-frame head triangle, which is unlikely to have changed significantly in size or location from the previous frame. In step 372, any candidate triangles that are too close to the triangles mapped in step 370 are discarded as candidates, as two users cannot occupy substantially the same space in the same frame. The process is then repeated in step 373 if there are any further previous frame active players.

The steps 370 and 372 may in particular include the following steps. For each previous-frame player, test each candidate triangle against the player. Then, apply penalties proportional to how much the triangle shape changed. Next, apply penalties proportional to how far the triangle (or its vertices) moved (penalties may be linear or nonlinear). Motion prediction (momentum) of the points may also be taken into account here. Then, take the triangle with the best score. If the score is above a threshold, assign the triangle to the previous-frame player and discard all other candidate triangles that are nearby. Repeat the above for each other previous-frame player. In other embodiments, different scoring criteria may be used for matching candidate triangles to the triangles of active players for the previous frame.

In step 374, for each inactive player, the top candidate triangles are mapped onto existing inactive players. Triangles may be mapped to an inactive player in the field of view based on the inactive player's previous-frame head triangle. In step 376, any candidate triangles that are too close to the triangles mapped in step 374 are discarded as candidates. The process is then repeated in step 377 if there are any further previous frame inactive players. Further details of steps 374 and 376 may be as described in the previous paragraph. Similarly, in step 378, for each potential player, the top candidate triangles are mapped onto identified potential players. Triangles may be mapped to a potential player in the field of view based on the potential player's previous-frame head triangle (if identified) or other known methods of identifying potential player locations. In step 380, any candidate triangles that are too close to the triangles mapped in step 378 are discarded. The process is then repeated in step 381 if there are any further previous frame potential players. Further details of steps 378 and 380 may be as described in the previous paragraph.

In step 382 (FIG. 5B), the limb identification engine 192 checks whether there are any good candidate triangles leftover which have not been mapped to a user or discarded. If so, these leftover good candidate triangles may be interpreted as belonging to a new user entering the field of view. In this instance, the leftover head triangles are assigned to that new user in step 384, and that new user is termed a potential user. The hand movements of that potential user are then tracked in successive frames as described above for hand movements.

Referring again to FIG. 4A, after identifying head triangles in step 308, the limb identification engine 192 finds hand proposals in step 310. These operations may be performed for all active users and potential users. In embodiments, the hand proposals for inactive players are not tracked, though they may be in further embodiments. The movement of head triangles may be tracked for active, inactive and potential users.

In embodiments, hand proposals may be found by various methods and combined together. A first method is using centroids with high probabilities of being correctly identified as hands. The system may use a number of such hand proposals such as for example seven per side (seven proposals per left hands and seven proposals per right hands). In addition to the centroid hand proposals selected on a given side, Exemplar may at times confuse which hand is which. Thus, an additional number of candidates, such as for example four more, may be taken for hand centroids on an opposite side of an associated shoulder. It is understood that more or less than these numbers of hand proposals may be used in further embodiments.

A second method of gathering hand proposals is by a technique referred to as magnetism. Magnetism involves the concept of “snapping” the location of a skeletal feature (such as a hand) from a previous frame or frames onto a new depth map. For example, if a left hand was identified for a user in a previous frame, and that hand is isolated (not touching anything), magnetism can accurately update that hand's location in the current frame using the new depth map. Additionally, where a hand is moving, tracking the movement of that hand over two or more previous frames may provide a good estimation of its position in the new frame. This predicted position can be used outright as a hand proposal; additionally or instead, this predicted position can be snapped onto the current depth map, using magnetism, to produce another hand proposal that better matches the current frame. In embodiments, the limb identification engine 192 may produce three hand proposals by magnetism per side per player (three for each player's left hand and three for each player's right hand), based on various starting points, as described below. In embodiments, it is understood that one or the other of centroids and magnetism may be used instead of both. Moreover, other techniques may be employed for finding hand proposals in further embodiments.

One special case of finding hand proposals by magnetism applies to checking for movement of a forearm along its axis, toward the hand. In this instance, magnetism may snap a user's hand to the middle of their forearm, which is undesirable. To accurately handle this case, the system may generate another hand proposal where the hand position is moved some distance down the lower arm, for example, 15% of the length of a user's forearm, and then snapped using magnetism. This will ensure that one of the hand proposals is correctly positioned, in the event of axial motion along the forearm.

Magnetism refines the location of a body part proposal by ‘snapping’ it to the depth map. This is most useful for terminating joints, such as hands, feet, and heads. In embodiments, this involves searching the nearby pixels in the depth map for the pixel that is closest (in 3D) to the location of the proposal. Once this ‘nearest point’ is found, that point may be used as the refined hand proposal. However, that point will usually be at the edge of the feature of interest (such as a hand), rather than at its center, which would be more desirable. Additional embodiments might then further refine the hand proposal, by searching for nearby pixels that fall within a certain distance (in 3D) of the ‘nearest point’ described above. This distance may be set to approximately match the expected diameter of the body part (such as the hand). Then, the locations of some or all of the pixels within this distance of the ‘nearest point’ may be averaged, to produce a further-refined position of the hand proposal. In embodiments, some of the pixels contributing to this average might be rejected, if a smooth path cannot be found that connects the ‘nearest pixel’ and the contributing pixel, although this may be omitted in embodiments

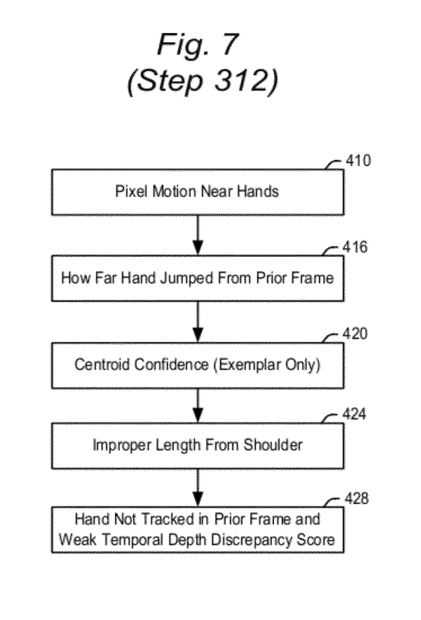

Once the hand proposals are found from the various methods in step 310, they are evaluated in step 312. As with the head triangles, hand proposals may be evaluated by running the various centroid and magnetism candidate hand proposals through various scoring subroutines. These subroutines are now explained in greater detail with respect to the flowchart of FIG. 7.

In step 410, a scoring subroutine which checks for pixel motion near the hand proposals may be run. This test detects how fast the pixels in the vicinity of a hand proposal are “moving”. In embodiments, this motion detection technique may be used to detect motion for other body part proposals, besides just hands. The field of view may be referenced by a Cartesian coordinate system where the Z-axis is straight out from the depth camera 20 and the X-Y plane is perpendicular to the Z-axis. Movement in the X-Y plane shows up as drastic/sudden depth changes at a given pixel location, when the depth value at that pixel location is compared between one frame and the next. The quantity of pixels (at various locations) undergoing such drastic Z-change gives an indication of how much X-Y movement there is, in the vicinity of the hand proposal.

Movement in the Z direction shows up as a net positive or negative average movement forward or back, among these pixels. Only the pixels near the hand proposal location (in the X-Y plane) whose depth values are close to the hand proposal's depth, in both the previous frame and in the new frame, should be considered. If, averaged together, the Z-displacements of these pixels all move forward or back, then this is an indication of general, spatially consistent motion of a hand in the Z direction. And in this case, the exact speed of the motion is known directly.

The X-Y movement and Z movement can then be combined, to indicate the overall amount of X, Y and Z hand motion, which can then be factored into the score of the hand proposal (and the score of any arm hypothesis that is built on this hand proposal as well). In general, XYZ motion in the vicinity of a hand proposal will tend to indicate that the hand proposal belongs to an animated being, rather than to an inanimate object such as a piece of furniture, and this will result in a higher score for that hand proposal in step 410. In embodiments, this score can be weighted more heavily for potential players, whom the system is attempting to validate as human or discard as non-human.

In step 416, the limb identification engine 192 may run a further scoring subroutine which checks how far a proposed hand jumped from the determined final prior-frame position of the hand to which the proposal refers. Larger jumps would tend to indicate that the current candidate is not a hand and the score would be decreased accordingly. A penalty here may be linear or non-linear.

For hand proposals generated by Exemplar, the limb identification engine 192 may further use the centroid confidence for a given hand proposal in step 420. High centroid confidence values would tend to increase the score for that hand proposal.

In step 424, the limb identification engine 192 may run a scoring subroutine which checks the distance of the hand proposal from the corresponding shoulder. If the distance from the shoulder is longer than the possible distance between the shoulder and the hand, the score is penalized accordingly. This maximum range of shoulder-to-hand distance can also be scaled according to the estimated player size, which can come from the head-shoulder triangle or from the arm length of the player, damped over time.

Another scoring subroutine may check in step 428 whether a hand proposal was not successfully tracked in the prior frame, coupled with a weak pixel motion score in step 410. This subroutine is based on the fact that if the hand was not tracked on the previous frame, then only hand proposals that meet or exceed a motion score threshold should be considered. The reason is so that non-moving depth features that look like arms or hands (such as the arm of a chair) are less likely to succeed; a hand has to move (which the furniture will not) to start tracking; but once it is moving, it can stop moving, and still be tracked. As explained below, given the known position of a shoulder identified by the head triangle matching, and a given hand candidate, a variety of possible elbow positions are calculated. Any of the above-described hand scoring subroutines may be run for each of the hand/elbow combinations found as described below. However, as none of the above-described hand scoring subroutines depend on the position of the elbow, it is more efficient from a processing standpoint to perform these subroutines prior to checking for various elbow positions. The scores from each of the scoring subroutines in FIG. 7 may be summed and stored for use as described below.

Referring again to FIG. 4A, in step 318, for each hand proposal, a number of elbow locations are tested, and the hand, elbow and shoulder for each elbow position are scored to provide a full arm hypothesis. The number of possible elbow locations may vary and may for example be between 10 and 100, though it may be more or less than that range in further embodiments. The number of elbow positions may also change dynamically. For a hand proposal and a fixed shoulder, an elbow position is selected and the overall arm hypothesis with the elbow in that position is scored, the next elbow position is selected and the overall arm hypothesis is scored, etc., until the desired number of elbow locations have been tested and arm hypotheses scored. Alternatively, the number of arm hypotheses scored may be determined dynamically, to maximally use the available computing time. This is performed for each hand proposal remaining after step 316 to determine a score for the various arm hypotheses.

In general, the possible elbow locations for a given hand proposal and known shoulder location are constrained to lie along a circle. The circle is defined by taking two points (shoulder and hand), and the known upper- and lower-arm lengths from previous frames (or an estimate, if this data is unavailable), and then mathematically computing the circle (center x, y, z and radius) upon which the elbow must lie, given these constraints. This problem has a well-known analytical solution; in general, it is a circle that describes all points that are at a distance D1 from point 1, and at a distance D2 from point 2. As long as the distance between the hand and shoulder is <D1+D2, then there is a valid circle. Candidate elbow positions may be selected on the defined circle. However, the positions may also be randomly perturbed. This is because the upper/lower arm lengths might not be correct, or the shoulder/hand position might be close but not perfect.

It is understood that candidate elbow positions may be found by other methods, including for example from elbow centroids. In further embodiments, completely random points may be selected for the elbow positions, the previous-frame elbow position may be used, or a momentum-projected elbow position may be used. These predictions may also be perturbed (moved about), and may be used more than once with different perturbations.

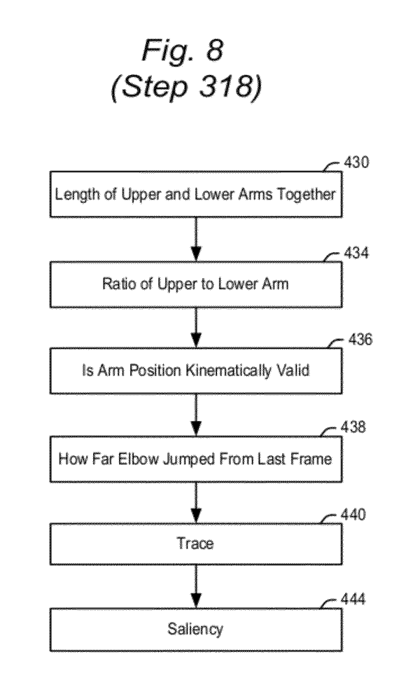

FIG. 8 presents further details of scoring subroutines which may be run for each elbow position for each hand proposal. In step 430, the limb identification engine 192 may measure the length of the upper arm and lower arm given by the current elbow position and hand proposal. Where the combined length of the upper and lower arms is either too large or too small, the score for that elbow position and hand proposal is penalized.

In step 434, instead of checking the total length, the limb identification engine 192 may run a subroutine checking the ratio of the upper arm length, to the sum of the upper and lower arm lengths, for that arm hypothesis. This ratio will almost universally be between 0.45 and 0.52 in human bodies. Any elbow position outside of that range may be penalized, with the penalty being proportional (but not necessarily linear) to the trespass outside of the expected range. In general, these scoring functions, as well as the other scoring functions described herein, may be continuous and differentiable.

In step 436, a scoring subroutine may be run which tests whether a given arm hypothesis is kinematically valid. That is, given a known range of motions of a person's upper and lower arms and the possible orientations of the arm to the torso, can a person validly have joint positions in a given arm hypothesis. If not, the arm hypothesis may be penalized or removed. In embodiments, the kinematically valid scoring subroutine may begin by translating and rotating a person's position in 3-D real world space to a frame of reference of the person's torso (independent of real world space). While operation of this subroutine may be done using a person's position/orientation in real world space in further embodiments, it is computationally easier to first translate the user to a frame of reference of the person's torso.

In this frame of reference, the ortho-normal basis vectors for torso space can be visualized as: +X is from the left shoulder to the right shoulder; +Y is up the torso/spine; and +Z is out through the player's chest (i.e., generally the opposite of +Z in world-space). Again, this frame of reference is by way of example only and may vary in further embodiments.

Thereafter, for a given upper arm position, the limb identification engine 192 checks whether a lower arm lies within a cone defining the possible positions (direction and angle) of the lower arm for the given upper arm position. Using the above-described ortho-normal basis vectors, the upper arm might lie along (or in-between) six ortho-normal vector positions (upper arm forward, upper arm back, upper arm left, upper arm right up and upper arm down). For each of these orthonormal directions of the upper arm, a corresponding cone that defines the possible directions of the lower arm is simple to specify and is generally known. Because the direction of the upper arm (in the hypothesis) is rarely aligned exactly to one of these six orthonormal directions, and instead often lies in-between several of them, the cone definitions associated with the nearest orthonormal upper-arm directions are blended together, to produce a new cone that is tailored for the specific direction in which the upper arm lies. In this blending, the cones of the axes along which the upper arm most closely aligns will receive more weight, and the cones of the axes that lie in the opposite direction of the upper arm will have zero weight. Once the blended cone is known, the lower arm is then tested to see if it lies within the cone. An arm hypothesis in which the lower arm's direction does not fall into the blended cone (of valid lower arm directions) may then be penalized, or if egregious, may be discarded. The penalty may be linear or non-linear.

It is understood that there are other methods of testing kinematically valid arm positions. Such methods include pose dictionary lookups, neural networks, or any number of other classification techniques.

In step 438, a scoring subroutine may be run which checks how far the current elbow position has jumped from a determined elbow position in the last frame. Larger jumps will be penalized more. This penalty may be linear or non-linear.

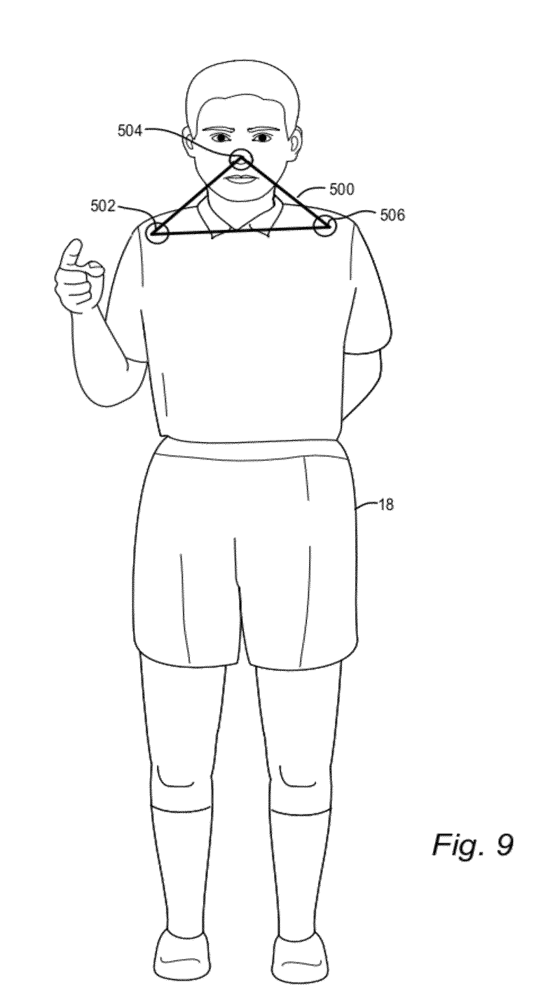

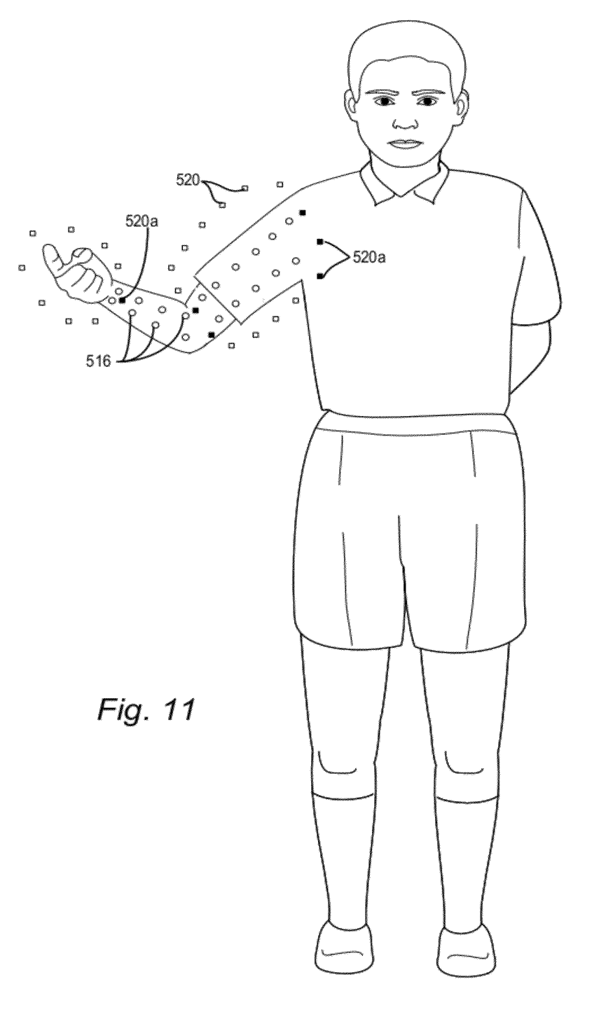

In steps 440 and 444, trace and saliency subroutines may be run on the arm hypothesis and scored. In particular, referring to FIG. 11, for a given hand proposal, elbow and known shoulder positions, trace samples 516 may be defined at a radius along the center line of the upper and lower arms. The radius is set small enough so as to guarantee that the samples are within the user's upper and lower arm, even for users with narrow arms. Once the trace samples are defined, the depth of the trace samples is then examined If an individual sample has a bad z mismatch with the depth map, then that trace sample gets a bad score. The scores from all samples may be tallied for the resulting score. It is noted that while the user 18 in FIGS. 9-11 has one arm behind his back, trace samples, as well as the saliency samples described below, may be taken for both the left and right arms. Moreover, in this example where a user's upper body is tracked, the user 18 in FIGS. 9-11 may alternatively be seated.

Similarly, saliency samples 520 are defined in circles, semicircles, or partial circles in the X-Y plane (perpendicular to the capture device 20) at the joints of the arms. The saliency samples can also lie in “rails”, as visible around the upper arm in FIG. 11, which are parallel lines on each side of the upper arm or lower arm, when these limb segments are not Z-aligned (the saliency samples around the lower arm are omitted in FIG. 11 for clarity). All of these samples, both on circles and rails, are set out at some distance (in the XY plane) away from the actual joints, or lines connecting the joints. The radius of a given sample must be large enough so that, if the hypothesis is correct, the samples will all lie just outside of the silhouette of the player's arm, even for a very bulky player. However, the radius should be no larger, in order to achieve optimum results.

Once the sample locations are laid out in XY, the observed and expected depth values can be compared at each sample location. Then, if any of the saliency samples indicate a depth that is similar to the depth of the hypothesis, those samples are penalized. For example, in FIG. 11, saliency samples 520A (shown as filled squares in the figure) would be penalized around the upper arm and hand. The scoring of the individual samples of the trace and saliency tests may be as described above for the trace and saliency tests when considering head triangles.

While above embodiments have commonly discussed trace and saliency operating together, it should be noted that they can be used individually and/or separately in further embodiments. For example, a system might use trace samples only, or saliency samples only, to score hypotheses around various body parts.

A score which is given by the trace and saliency subroutines may be weighted higher than the other subroutines shown in FIGS. 7 and 8. However, it is understood that the different subroutines in FIGS. 7 and 8 may be accorded different weights in different embodiments. Moreover, it is understood that the subroutines shown in FIGS. 7 and 8 are by way of example only, and that other or alternative subroutines may be used in further embodiments to evaluate hand proposals and possible elbow locations.

Once the scores for all arm hypotheses are determined, the arm hypotheses having the highest score(s) are identified in step 322 of FIG. 4A. This represents a strong indicator of the positions of a user's left and right arms including hand, wrist, lower arm and upper arm for that frame. In step 326, an attempt is made to refine the elbow position on the highest scoring arm proposals by moving the elbow position around in the vicinity of the identified elbow position. In step 328, the limb identification engine 192 checks whether the arm hypotheses with refined elbow positions result in higher arm position scores. If so, the refined arm hypotheses replace the former highest-scoring hypotheses in step 332. Steps 326 through 332 are optional and may be omitted in further embodiments.

In step 336, the highest-scoring arm positions for a user's left and right arms are compared with some predefined threshold confidence value. In embodiments, this threshold can change based on whether or not the hand was reported with confidence on the previous frame, or not, or based on other factors. Referring now to FIG. 4B, if the high scoring left or right arm is lower than the threshold in step 340, then a no confidence report is made, and no arm data is returned for that arm, for that frame in step 342.

If a no confidence report is made for a given arm in step 342, the system may return a no confidence value, and no data, for the arm for this frame. In this event, the system may skip to step 354 to see if any potential players may be validated or removed as explained below. If one arm scores above the threshold and one does not, the system may return data for the arm that is above the threshold. On the other hand, if both arms scored higher than the threshold in step 340, then step 346 returns positions for all joints in the upper body including the head, shoulders, elbows, wrists and hands. As explained below, these head, shoulder and arm positions are provided to the computing environment 12 to perform any of various actions, including gesture recognition and interaction with virtual objects presented on display 14 by an application running on the computing environment 12.

In step 350, the limb identification engine 192 may optionally try to refine the identified position of a user's hands. In step 350, the limb identification engine 192 may find and tag pixels that are furthest from the lower arm along a world-space vector from the elbow to the hand, and which pixels are also connected to the hand in the frame depth map. A number of or all of these pixels may then be averaged together to refine a user's hand position.

Further, these pixels may be scored based on how far along the elbow-to-hand vector they lie. Then, a number of the highest-scoring pixels in this set may be averaged to produce a smooth hand tip location, and a number of the next-highest-scoring pixels in this set may be averaged to produce a smooth wrist location. Further, a smooth hand direction may be derived from a vector between these two locations. The number of pixels used may be based on the depth of the hand proposal, an estimate of the user's size, or other factors.

Further, a bounding radius might be used while searching for connected pixels, this radius based on the maximum expected radius of an open hand, adjusted for a player's size and for the depth of the hand. If positive-scoring pixels are found that hit this bounding radius, then this is evidence that the hand tip refinement is likely to fail (spilling into some object or body part beyond the hand), and the refined hand tip can be reported with no confidence. Step 350 operates best when the user's hand is not in contact with other objects, which is often the case for arms that have sufficient saliency scores to pass the confidence test. Step 350 is optional and may be omitted in further embodiments.

As indicated above, where good head triangles are identified in a frame which are not yet associated with an active or inactive user, these head triangles are tagged as potential players. In step 354, the limb identification engine 192 checks whether these identified potential players performed human hand movements as explained below. If not, the engine 192 may determine in step 355 if enough time has passed or whether more time is needed in which to keep searching for hand movements. If enough time has passed without being able to confirm human hand movements from the potential player, the potential player may be dropped as being false in step 356. If not enough time has passed in step 355 to conclude whether or not the potential player has made human hand movements, the system may return to step 304 in FIG. 4A to obtain a next frame of data and repeats the steps shown in FIGS. 4A through 8.

At the end of each frame, for each potential player, the limb identification engine 192 attempts to determine whether a potential player is human. First, the head- and hand-tracking history is examined for the past fifteen or so frames. It may be more or less frames than that in further embodiments. If the potential player has existed for the selected number of frames, the following may be checked: 1) whether, on all of these frames, the head triangle was strongly tracked, and 2) whether on all of these frames, either the left or right hand was consistently tracked, and 3) whether that hand moved by at least a minimum net distance along a semi-smooth path during these frames, for example 15 cm, though it may be more or less than that in further embodiments. If so, the player is then considered “verified as human” and is upgraded to active or inactive.

If fifteen frames has not elapsed since the player was first tracked, but any of the above constraints are violated early, the potential player may be discarded as not being human to allow new potentials to be chosen on the next frame. For example, if on the fifth frame of a potential player's existence, neither hand was able to be tracked, then that potential player can be immediately destroyed.

Certain other tests may also be used in this determination. The “minimum net distance” test is designed to fail background objects that have no motion. The “semi-smooth path” test is designed to pass human hands doing almost any human hand movement, but to almost always fail background objects that are in random, chaotic motion (usually due to camera noise). Human hand motion, when observed at (around) 30 Hz, is almost always semi-smooth, even if the human is trying to make movements that are as fast and sharp as possible. There are a wide variety of ways to design the semi-smooth test.

As an example, one such embodiment works as follows. If there are fifteen frames of location history for a hand, the middle eleven frames may be considered. For each frame, an alternate location may be reconstructed as follows: 1) the location of the hand is predicted, based only on the locations in the prior two frames, using a simple linear projection; 2) the location of the hand is reverse-predicted, based on the locations in the subsequent two frames, using a simple linear projection; 3) the average of the two predictions is taken; 4) the average is compared to the observed location of the hand on that frame. This is the “error” for this frame.

The “error” for the eleven frames is summed The distance traveled by the hand, frame-to-frame, for the eleven frames is also summed The error sum is then divided by the net distance traveled. If the result is above a certain ratio (such as for example 0.7), the test fails; otherwise, the test passes. It is understood that other methods may be used to determine whether a potential player is verified as human and upgraded to an active or inactive player.

If the potential player is verified as human in step 354 as described above, this potential player is upgraded in step 358 to an inactive or active player. After performing either steps 356 or 358, the system may return to step 304 in FIG. 4A to obtain a next frame of data and repeats the steps shown in FIGS. 4A through 8. In this manner, the present technology may evaluate data received from capture device 20 in each frame, and identify a skeletal position of one or more joints of one or more users in that frame.

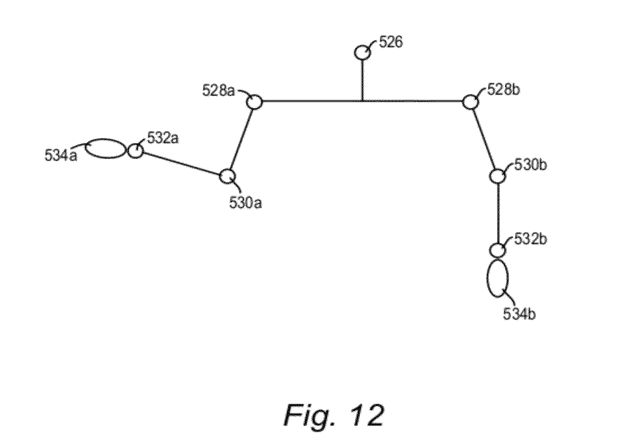

For example, as shown in FIG. 12, the limb identification engine 192 may return the positions of a head 522, shoulders 524a and 524b, elbows 526a and 526b, wrists 528a and 528b, and hands 530a and 530b. The positions of the various joints shown in FIG. 12 are by example only and they vary in any possible user position in further examples. It is also understood that the measurement of only some of a user's joints has potential benefits beyond processing efficiency. Focus on a particular set of joints may further be done to avoid the possibility of receiving and processing conflicting gestures. The joints not tracked are ignored when determining whether a given gesture has been performed.

In the embodiment described above, the limb identification engine 192 was used to identify joints in a user's upper body. It will be understood that the same techniques may be used to discover joints in a user's lower body. Moreover, certain users such as those recovering from a stroke, may only have use of a left side or a right side of their body. The technique described above may be used to track the left or right side of a user's body as well. In general, any number of joints may be tracked. In further embodiments, the present system as described above may be used to track all joints in a user's body. Additional features may also be identified, such as the bones and joints of the fingers or toes, or individual features of the face, such as the nose and eyes.

Focusing on only a fraction of a user's body joints, the present system is able to process image data more efficiently than in systems which measure all body joints. This may result in faster processing and reduced latency in rendering objects. Alternatively and/or additionally, this may allow additional processing to be performed within a given frame rate. This additional processing may, for example, be used in performing more scoring subroutines to further ensure the accuracy of the joint data that is generated at each frame.

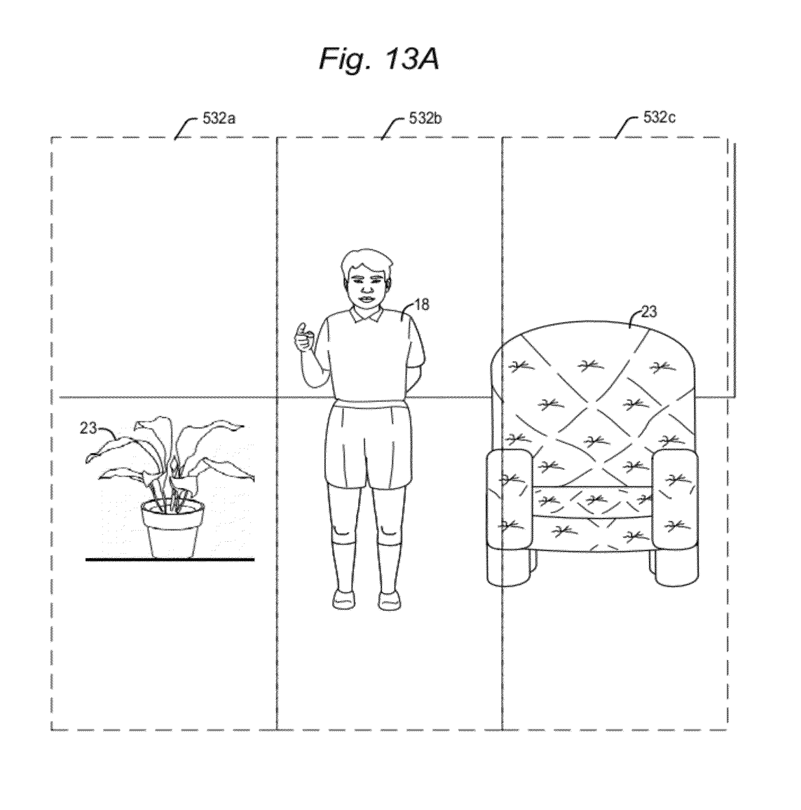

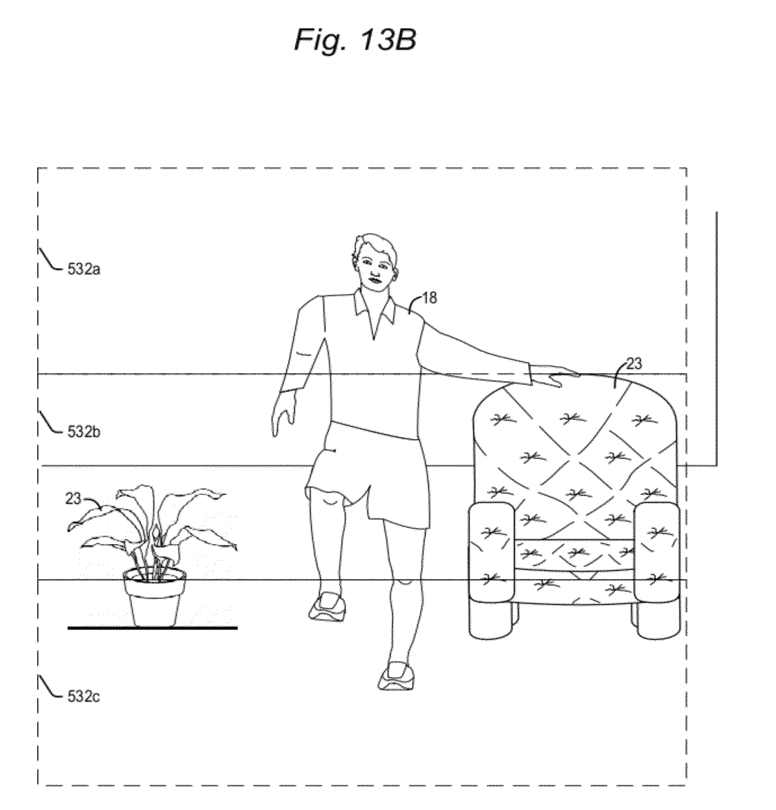

In order to further aid in processing efficiency, a capture device capturing image data may segment the field of view in smaller areas, or zones. Such an embodiment is shown for example in FIGS. 13A and 13B. In FIG. 13A, the FOV is segmented into three vertically oriented zones 532a, 532b and 532c. An assumption may be made that a user will in general stand directly in front of a capture device 20. As such, most of the movement to be tracked will be in the center zone 532b. In embodiments, the capture device 20 may focus exclusively on a single zone, such as zone 532b. Alternatively, the capture device may cycle through the zones in successive frames, so that frame data is read from each zone once every three frames in this example. In further embodiments, the capture device may focus on a single zone such as center zone 532b, but periodically scan the remaining zones once every predefined number of frames. Other scanning scenarios of the respective zones 532a, 532b and 532c are contemplated. Moreover, the segmentation into three zones is by way of example only. There may be two zones or more than three zones in further embodiments. While the zones are shown having a clear border, the zones may overlap with each other slightly in further embodiments.

As a further example, FIG. 13B shows the zones 532a, 532b and 532c horizontally. The scanning of the various zones 532a, 523b and/or 532c in FIG. 13B may be in accordance with any of the examples discussed above with respect to FIG. 13A. While FIGS. 13A and 13B show two dimensional segmenting, either or both of these embodiments may further have a depth component in addition to X-Y or instead of X or Y. Thus the zones may be two dimensional or three dimensional.

In accordance with a further aspect of the present technology, only certain gestures or actions may be allowed in certain zones. Thus, the capture device may scan all zones in FIG. 13B, but for example, in zone 532a, only gestures and movements of the user's head may be tracked. In zone 532b, only gestures and movements of the user's knees are tracked. And in zone 532c, only gestures and movements of the user's feet are tracked. Such an embodiment may be useful depending on the application running on the computing environment 12, such as for example a European football (American soccer) game. The above is by way of example only. Other body parts in any number of zones may be tracked.

In operation, it may be identified when a virtual object moves into a machine space position corresponding to one of the real world zones 523a, 532b and 532. A set of permitted gestures may then be retrieved based on the zone the moving object is within. Gesture recognition (explained below) may proceed normally, but on a limited number of permissible gestures. The gestures which may be allowed in a given zone may be defined in an application running on computing environment 12, or otherwise stored in the memory of computing environment 12 or capture device 20. Gestures performed from other body parts not so defined may be ignored, while that same gesture affects some associated action if performed by a body part included within the definition of body parts from which gestures are accepted.

This embodiment has been described as accepting only certain defined gestures in a given zone, depending on whether the gesture performed in that zone is defined for that zone. This embodiment may further operate where the FOV is not divided into zones. For example, the system 10 may operate with a definition of only certain body parts from which gestures will be accepted. Such a system simplifies the recognition process and prevents overlap of gestures.

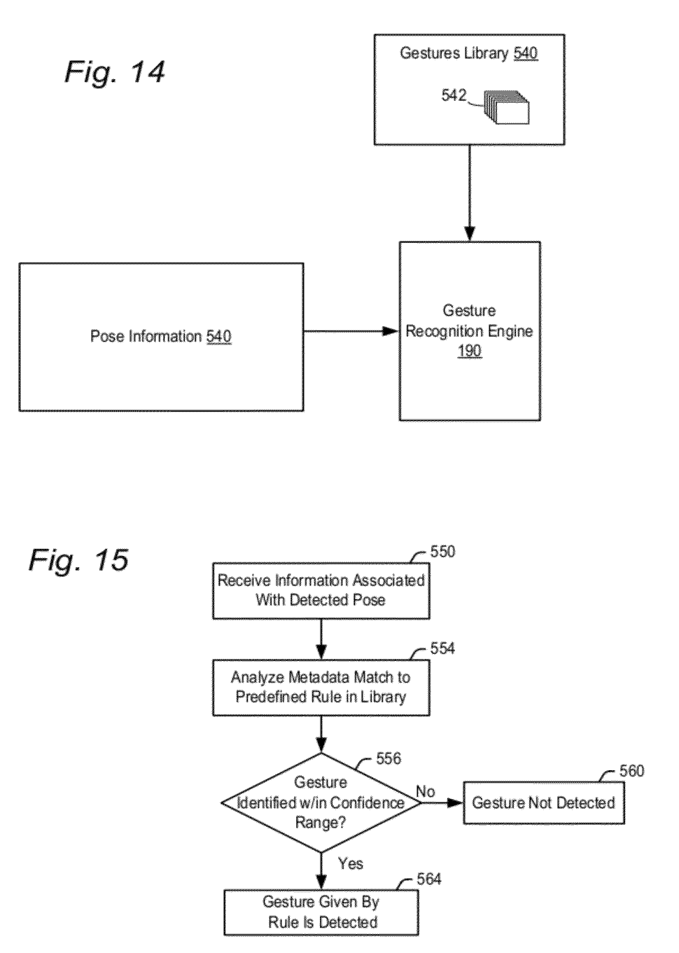

FIG. 14 shows a block diagram of a gesture recognition engine 190, and FIG. 15 shows a flowchart of the operation of the gesture recognition engine 190 of FIG. 14. The gesture recognition engine 190 receives pose information 540 in step 550. The pose information may include a variety of parameters relating to position and/or motion of the user's body parts and joints as detected in the image data.

The gesture recognition engine 190 analyzes the received pose information 540 in step 554 to see if the pose information matches any predefined rule 542 stored within a gestures library 540. A stored rule 542 describes when particular positions and/or kinetic motions indicated by the pose information 540 are to be interpreted as a predefined gesture. In embodiments, each gesture may have a different, unique rule or set of rules 542. Each rule may have a number of parameters (joint position vectors, maximum/minimum position, change in position, etc.) for one or more of the body parts shown in FIG. 12. A stored rule may define, for each parameter and for each body part 526 through 534b shown in FIG. 12, a single value, a range of values, a maximum value, a minimum value or an indication that a parameter for that body part is not relevant to the determination of the gesture covered by the rule. Rules may be created by a game author, by a host of the gaming platform or by users themselves.

The gesture recognition engine 190 may output both an identified gesture and a confidence level which corresponds to the likelihood that the user's position/movement corresponds to that gesture. In particular, in addition to defining the parameters required for a gesture, a rule may further include a threshold confidence level required before pose information 540 is to be interpreted as a gesture. Some gestures may have more impact as system commands or gaming instructions, and as such, require a higher confidence level before a pose is interpreted as that gesture. The comparison of the pose information against the stored parameters for a rule results in a cumulative confidence level as to whether the pose information indicates a gesture.

Once a confidence level has been determined as to whether a given pose or motion satisfies a given gesture rule, the gesture recognition engine 190 then determines in step 556 whether the confidence level is above a predetermined threshold for the rule under consideration. The threshold confidence level may be stored in association with the rule under consideration. If the confidence level is below the threshold, no gesture is detected (step 560) and no action is taken. On the other hand, if the confidence level is above the threshold, the user's motion is determined to satisfy the gesture rule under consideration, and the gesture recognition engine 190 returns the identified gesture in step 564.

The embodiments set forth above provide examples for tracking specific joints and/or tracking specific zones. Such embodiments may be used in a wide variety of scenarios. In one scenario shown in FIG. 1A, the user 18 is interacting with a user interface 21. In such embodiments, the system need only track a user's head and hands. The application running on computing environment 12 is set to receive inputs from only certain joints (such as head and hands), and therefore may indicate to the limb identification engine 192 which joints or zones should be tracked.

In a further embodiment, some user interface with the NUI system may be provided where a user can indicate which joints are to be tracked and/or which zones are to be tracked. The user interface would allow a user to make permanent settings, or temporary settings. For example, where a user has injured his or her right arm and it is immobilized for a period of time, the system may be set to ignore that limb for that period of time.

In a further embodiment, a user may be in a wheelchair as shown in FIG. 1C, or be differently-abled in some other way. A further example is a stroke victim who has use of only the left or right side of his body. In general, a user here may have limited use or control over certain parts of his or her body. In such instances, the present system may be set by the user to recognize and track movements from only certain joints and/or certain zones. This may be accomplished either by gesture or some other manual interaction with a user interface.

NUI systems often involve a user 18 controlling the movements and animation of an onscreen avatar 19 in a monkey-see, monkey-do (MSMD) manner. In embodiments where a differently-abled user is controlling an avatar 19 in MSMD mode, then the input data from the one or more inactive limbs may be ignored, and replaced with pre-canned animation. For example, in a scene where a wheelchair user is controlling an avatar to “walk” across a virtual field, the positional motion of the avatar may be guided by the upper torso and head, and a walking animation played for the avatar's legs rather than the MSMD mapping of the limbs.

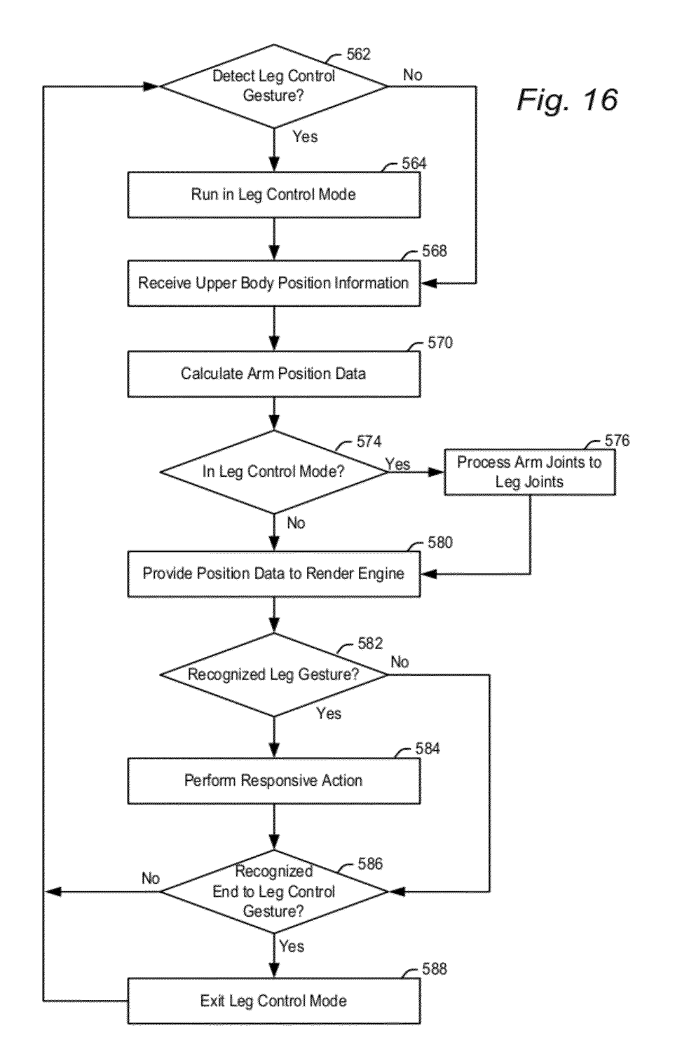

In some embodiments, the motion of a non-working limb may be needed for a given action or interaction with the NUI system to be accomplished. In such embodiments, the present system allows for a user-defined remapping of limbs. That is, the system allows a user to substitute a working limb for the non-working limb so that the movements of the user's working limb get mapped onto the intended limb of the avatar 19. One such embodiment for accomplishing this is now explained with reference to the flowchart of FIG. 16.

In FIG. 16, the arm data returned by the limb identification engine 192 may be used to animate and control the legs of an avatar on-screen. In normal MSMD operation, movement of a user's arm or arms results in corresponding movement of an avatar's arm or arms on-screen. However, a predefined gesture may be defined which, when made and recognized, switches to a leg control mode where movement of a user's arms results in movement of the avatar's legs on-screen. If such a gesture is detected by gesture recognition engine 190 in step 562, the computing environment 12 may run in a leg control mode in 564. If no such gesture is detected in step 562, steps 568 through 588 described below may result in normal MSMD operation.

In either event, in step 568, the capture device and/or computing environment receive the upper body position information, and head, shoulder and arm position may be calculated to step 570 as described above by the limb identification engine 192. In step 574, the system checks whether it is running in leg control mode. If so, the computing environment 12 may process the arm joints in a user's right and/or left arms to 3-D real world positions of leg joints for a user's left and/or right legs.

This may be done a number of ways. In one embodiment, movement of the user's arm in real space may be mapped to a leg of an onscreen avatar 19, or otherwise interpreted as leg input data. For example, the shoulder joint may be mapped to a user's hip over some range of motion by a predefined mathematical function. A user's elbow may be mapped to a user's knee over some range of motion by a predefined mathematical function (taking into account the fact that the elbow moves the lower arm in an opposite direction than the knee moves the lower leg). And a user's wrist may be mapped to the user's ankle over some range of motion by a mathematical function.

Upon such mapping, a user may for example move his shoulder, elbow, and wrist in concert and in such a way so as to create an impression that the user's leg is walking or running As a further example, a wheelchair user may mimic the action of kicking a ball by moving his arm. The system maps the gross level motions to the avatar's skeleton and may use an animation blend to allow it to appear as if it were a leg motion. It is understood that a user may substitute a working limb with a non-working limb without the above steps or through alternative steps.

In embodiments, one of the user's arms may control one of an avatar's legs while in leg control mode, while the user's other arm is controlling one of the avatar's arms. In such embodiments, the avatar leg not controlled by the user may simply make mirror movements to the controlled leg. Thus, when a user moves his arm and takes a step with the left foot, the avatar may follow that left leg step with a corresponding right leg step. In further embodiments, when in leg control mode, a user may control both of an avatar's legs with both of his arms in the real world. It is understood that a variety of other methods may be used to process the position of arm joints to leg joints in further embodiments so as to control an avatar's legs.

In step 580, the joint positions (either processed in step 576 in leg control mode or not) are provided to computing environment 12 for rendering by the GPU. In addition to controlling the movement of an avatar's legs, a user may perform certain arm gestures which may be interpreted as leg gestures when in leg control mode. In step 582, the system checks for recognized leg gestures. This leg gesture may be performed by a user's leg in the real world (when not in leg control mode), or by a user's arm (when in leg control mode). If such a gesture is recognized by the gesture recognition engine in step 582, the responsive action is performed in step 584.

Whether a particular leg gesture is recognized in step 582 or not, the system next checks in step 586 whether some gesture predefined to end leg control mode is performed. If so, the system exits leg control mode in step 588 and returns to step 562 to begin the process again. On the other hand, if no gesture was detected in step 586 to end leg control mode, then step 588 is skipped and the system returns to step 562 to repeat the steps.

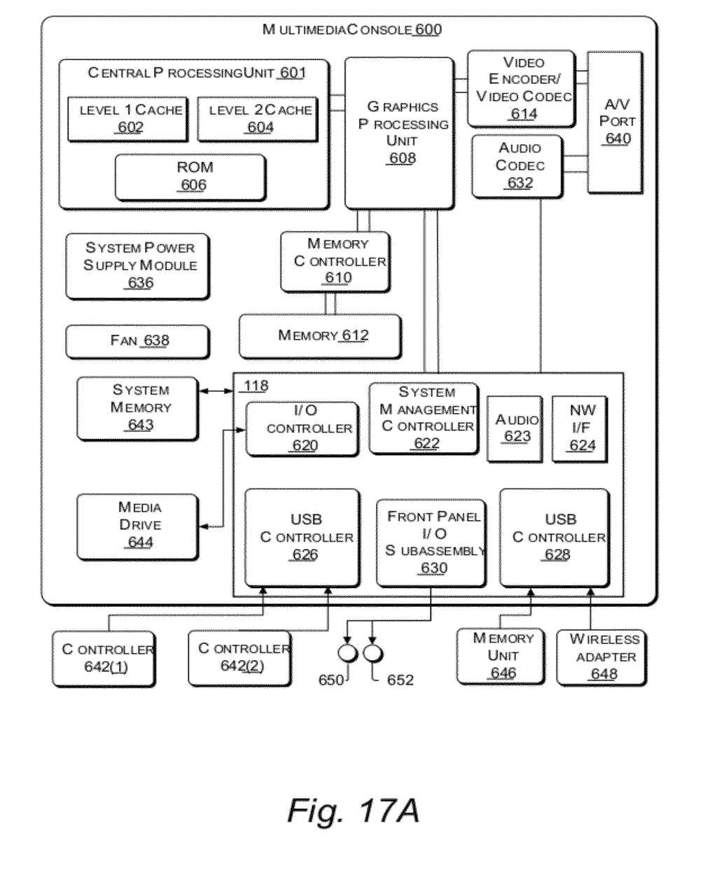

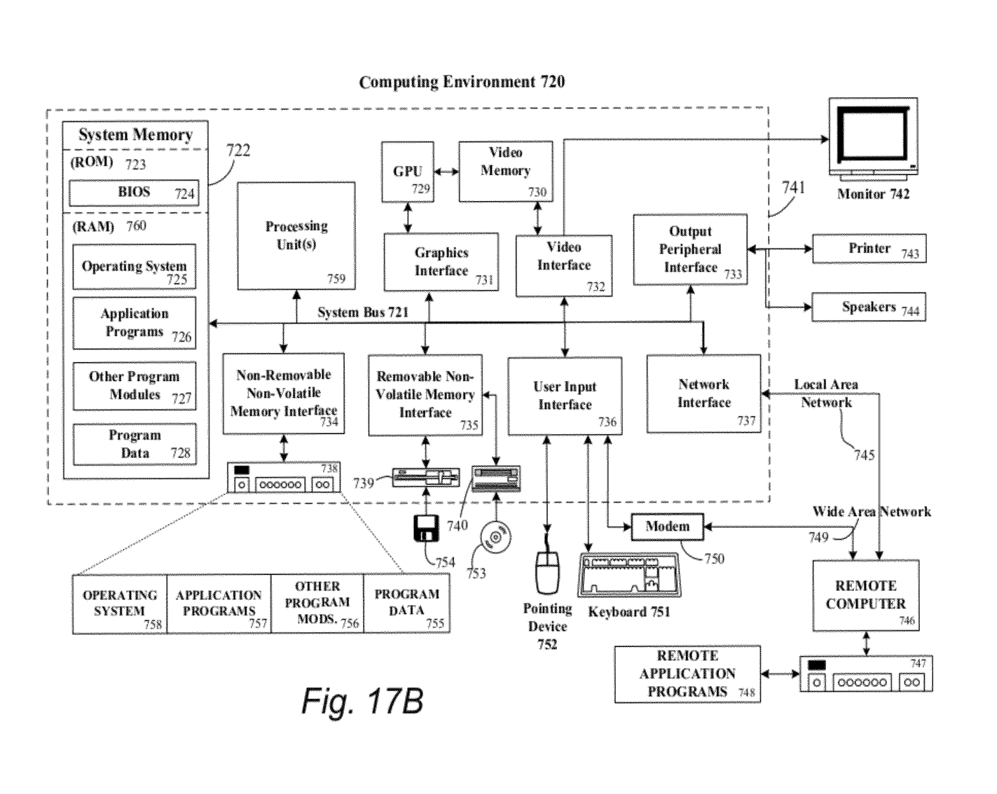

FIG. 17A illustrates an example embodiment of a computing environment that may be used to interpret one or more positions and motions of a user in a target recognition, analysis, and tracking system. The computing environment such as the computing environment 12 described above with respect to FIGS. 1A-2 may be a multimedia console 600, such as a gaming console. As shown in FIG. 17A, the multimedia console 600 has a central processing unit (CPU) 601 having a level 1 cache 602, a level 2 cache 604, and a flash ROM 606. The level 1 cache 602 and a level 2 cache 604 temporarily store data and hence reduce the number of memory access cycles, thereby improving processing speed and throughput. The CPU 601 may be provided having more than one core, and thus, additional level 1 and level 2 caches 602 and 604. The flash ROM 606 may store executable code that is loaded during an initial phase of a boot process when the multimedia console 600 is powered ON.

A graphics processing unit (GPU) 608 and a video encoder/video codec (coder/decoder) 614 form a video processing pipeline for high speed and high resolution graphics processing. Data is carried from the GPU 608 to the video encoder/video codec 614 via a bus. The video processing pipeline outputs data to an A/V (audio/video) port 640 for transmission to a television or other display. A memory controller 610 is connected to the GPU 608 to facilitate processor access to various types of memory 612, such as, but not limited to, a RAM.

The multimedia console 600 includes an I/O controller 620, a system management controller 622, an audio processing unit 623, a network interface controller 624, a first USB host controller 626, a second USB host controller 628 and a front panel I/O subassembly 630 that are preferably implemented on a module 618. The USB controllers 626 and 628 serve as hosts for peripheral controllers 642(1)-642(2), a wireless adapter 648, and an external memory device 646 (e.g., flash memory, external CD/DVD ROM drive, removable media, etc.). The network interface 624 and/or wireless adapter 648 provide access to a network (e.g., the Internet, home network, etc.) and may be any of a wide variety of various wired or wireless adapter components including an Ethernet card, a modem, a Bluetooth module, a cable modem, and the like.

System memory 643 is provided to store application data that is loaded during the boot process. A media drive 644 is provided and may comprise a DVD/CD drive, hard drive, or other removable media drive, etc. The media drive 644 may be internal or external to the multimedia console 600. Application data may be accessed via the media drive 644 for execution, playback, etc. by the multimedia console 600. The media drive 644 is connected to the I/O controller 620 via a bus, such as a Serial ATA bus or other high speed connection (e.g., IEEE 1394).

The system management controller 622 provides a variety of service functions related to assuring availability of the multimedia console 600. The audio processing unit 623 and an audio codec 632 form a corresponding audio processing pipeline with high fidelity and stereo processing. Audio data is carried between the audio processing unit 623 and the audio codec 632 via a communication link. The audio processing pipeline outputs data to the A/V port 640 for reproduction by an external audio player or device having audio capabilities.

The front panel I/O subassembly 630 supports the functionality of the power button 650 and the eject button 652, as well as any LEDs (light emitting diodes) or other indicators exposed on the outer surface of the multimedia console 600. A system power supply module 636 provides power to the components of the multimedia console 600. A fan 638 cools the circuitry within the multimedia console 600.

The CPU 601, GPU 608, memory controller 610, and various other components within the multimedia console 600 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 600 is powered ON, application data may be loaded from the system memory 643 into memory 612 and/or caches 602, 604 and executed on the CPU 601. The application may present a graphical user interface that provides a consistent user experience when navigating to different media types available on the multimedia console 600. In operation, applications and/or other media contained within the media drive 644 may be launched or played from the media drive 644 to provide additional functionalities to the multimedia console 600.

The multimedia console 600 may be operated as a standalone system by simply connecting the system to a television or other display. In this standalone mode, the multimedia console 600 allows one or more users to interact with the system, watch movies, or listen to music. However, with the integration of broadband connectivity made available through the network interface 624 or the wireless adapter 648, the multimedia console 600 may further be operated as a participant in a larger network community.

When the multimedia console 600 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 600 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 601 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 642(1) and 642(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 600.

FIG. 17B illustrates another example embodiment of a computing environment 720 that may be the computing environment 12 shown in FIGS. 1A-2 used to interpret one or more positions and motions in a target recognition, analysis, and tracking system. The computing system environment 720 is only one example of a suitable computing environment and is not intended to suggest any limitation as to the scope of use or functionality of the presently disclosed subject matter. Neither should the computing environment 720 be interpreted as having any dependency or requirement relating to any one or combination of components illustrated in the Exemplary operating environment 720. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 17B, the computing environment 720 comprises a computer 741, which typically includes a variety of computer readable media. Computer readable media can be any available media that can be accessed by computer 741 and includes both volatile and nonvolatile media, removable and non-removable media. The system memory 722 includes computer storage media in the form of volatile and/or nonvolatile memory such as ROM 723 and RAM 760. A basic input/output system 724 (BIOS), containing the basic routines that help to transfer information between elements within computer 741, such as during start-up, is typically stored in ROM 723. RAM 760 typically contains data and/or program modules that are immediately accessible to and/or presently being operated on by processing unit 759. By way of example, and not limitation, FIG. 17B illustrates operating system 725, application programs 726, other program modules 727, and program data 728. FIG. 17B further includes a graphics processor unit (GPU) 729 having an associated video memory 730 for high speed and high resolution graphics processing and storage. The GPU 729 may be connected to the system bus 721 through a graphics interface 731.

The computer 741 may also include other removable/non-removable, volatile/nonvolatile computer storage media. By way of example only, FIG. 17B illustrates a hard disk drive 738 that reads from or writes to non-removable, nonvolatile magnetic media, a magnetic disk drive 739 that reads from or writes to a removable, nonvolatile magnetic disk 754, and an optical disk drive 740 that reads from or writes to a removable, nonvolatile optical disk 753 such as a CD ROM or other optical media. Other removable/non-removable, volatile/nonvolatile computer storage media that can be used in the Exemplary operating environment include, but are not limited to, magnetic tape cassettes, flash memory cards, digital versatile disks, digital video tape, solid state RAM, solid state ROM, and the like. The hard disk drive 738 is typically connected to the system bus 721 through a non-removable memory interface such as interface 734, and magnetic disk drive 739 and optical disk drive 740 are typically connected to the system bus 721 by a removable memory interface, such as interface 735.

The drives and their associated computer storage media discussed above and illustrated in FIG. 17B, provide storage of computer readable instructions, data structures, program modules and other data for the computer 741. In FIG. 17B, for example, hard disk drive 738 is illustrated as storing operating system 758, application programs 757, other program modules 756, and program data 755. Note that these components can either be the same as or different from operating system 725, application programs 726, other program modules 727, and program data 728. Operating system 758, application programs 757, other program modules 756, and program data 755 are given different numbers here to illustrate that, at a minimum, they are different copies. A user may enter commands and information into the computer 741 through input devices such as a keyboard 751 and a pointing device 752, commonly referred to as a mouse, trackball or touch pad. Other input devices (not shown) may include a microphone, joystick, game pad, satellite dish, scanner, or the like. These and other input devices are often connected to the processing unit 759 through a user input interface 736 that is coupled to the system bus, but may be connected by other interface and bus structures, such as a parallel port, game port or a universal serial bus (USB). The cameras 26, 28 and capture device 20 may define additional input devices for the console 700. A monitor 742 or other type of display device is also connected to the system bus 721 via an interface, such as a video interface 732. In addition to the monitor, computers may also include other peripheral output devices such as speakers 744 and printer 743, which may be connected through an output peripheral interface 733.

The computer 741 may operate in a networked environment using logical connections to one or more remote computers, such as a remote computer 746. The remote computer 746 may be a personal computer, a server, a router, a network PC, a peer device or other common network node, and typically includes many or all of the elements described above relative to the computer 741, although only a memory storage device 747 has been illustrated in FIG. 17B. The logical connections depicted in FIG. 17B include a local area network (LAN) 745 and a wide area network (WAN) 749, but may also include other networks. Such networking environments are commonplace in offices, enterprise-wide computer networks, intranets and the Internet.

When used in a LAN networking environment, the computer 741 is connected to the LAN 745 through a network interface or adapter 737. When used in a WAN networking environment, the computer 741 typically includes a modem 750 or other means for establishing communications over the WAN 749, such as the Internet. The modem 750, which may be internal or external, may be connected to the system bus 721 via the user input interface 736, or other appropriate mechanism. In a networked environment, program modules depicted relative to the computer 741, or portions thereof, may be stored in the remote memory storage device. By way of example, and not limitation, FIG. 17B illustrates remote application programs 748 as residing on memory device 747. It will be appreciated that the network connections shown are Exemplary and other means of establishing a communications link between the computers may be used.

In embodiments, the present technology relates to a system for identifying users in a field of view from image data captured by a capture device, the system comprised of a stateless body part proposal system.

In embodiments, stateless body part proposal system produces body part proposals and/or skeletal hypotheses.

In embodiments, stateless body part proposal system produces body part proposals for head triangles, hand proposals and/or arm hypotheses.

In embodiments, the stateless body part proposal system may operate by Exemplar plus centroids.

In embodiments, the present technology relates to a system for identifying users in a field of view from image data captured by a capture device, the system comprised of a stateful body part proposal system.

In embodiments, the stateless body part proposal system may operate by magnetism.

In embodiments, stateless body part proposal system using magnetism produces body part proposals and/or skeletal hypotheses.

In embodiments, stateless body part proposal system using magnetism produces body part proposals for head triangles, hand proposals and/or arm hypotheses.

In embodiments, the present technology relates to a system for identifying users in a field of view from image data captured by a capture device, the system comprised of a body part proposal system and a skeleton resolution system for reconciling the proposals generated by the body part proposal system.

In embodiments the skeleton resolution system employs one or more cost functions, or robust scoring tests, for reconciling the candidate the proposals generated by the body part proposal system.

In embodiments, the skeleton resolution system uses a large number of body part proposals and/or skeletal hypotheses.

In embodiments, the skeleton resolution system uses trace and/or saliency samples to evaluate and reconcile candidate proposals, and/or combinations of candidate proposals, generated by the body part proposal system.

In embodiments, the trace samples test whether a detected depth value for a sample within one or more candidate body parts and/or skeletal hypotheses is as expected if the candidate body parts and/or skeletal hypotheses are correct.

In embodiments, the saliency samples test whether a detected depth value for a sample outside an outline of one or more candidate body parts and/or skeletal hypotheses is as expected if the candidate body parts and/or skeletal hypotheses are correct.

In embodiments, the trace and/or saliency samples may be used to score hypotheses about any and all body parts, or even entire skeletal hypotheses.

In embodiments, the skeleton resolution system uses a test for determining if a body part is in motion.

In embodiments the test for determining if a hand is in motion detects pixel motion in the x, y and/or z direction which corresponds to motion of the body part.

In embodiments, the pixel motion test detects the motion of hand proposals.

In embodiments, the pixel motion test detects the motion of a head, arms, legs and feet.

In embodiments, a skeleton is not validated until pixel motion is detected near a key body part (such as a hand or head).

In embodiments, a skeleton is not validated until a key body part is observed to follow a semi-smooth path over time.

In embodiments, the skeleton resolution system determines whether a given skeletal hypothesis is kinematically valid.

In embodiments, the skeleton resolution system determines whether one or more joints in a skeletal hypothesis are rotated past the joint rotation limits for the expected body parts.

In embodiments, the present system further includes a hand refinement technique which, in conjunction with the skeleton resolution system, produces extremely robust refined hand positions.

In the embodiments above, the skeleton resolution system first identifies players based on head and shoulder joints, and subsequently identifies the locations of the hands and elbows. In further embodiments, the skeleton resolution system might first identify players on any subset of body joints, and subsequently identify the locations of other body joints.

Further, the order of the identification of body parts by the skeleton resolution system might be different than described so far. Any body part, such as for example the torso, the hips, a hand, or a leg, might be resolved first and bound to players from previous frames, and subsequently, the rest of the skeleton might be resolved using the techniques described above for the arms, but applied to other body parts.

Further, the order of the identification of body parts by the skeleton resolution system might be dynamic. In other words, the first group of body parts to be resolved might depend on dynamic conditions. For example, if a player is standing sideways and their left arm is the most clearly visible part of their body, the skeleton resolution system might identify the player using that arm (rather than the head triangle), and subsequently resolve other parts of the skeleton and/or the skeleton as a whole.

In embodiments, the present system further includes methods for accurately determining both the position of the tip of the hand, as well as the angle of the hand.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method of gesture recognition, comprising:
a) segmenting a field of view of a scene into a plurality of zones;
b) defining one or more recognizable gestures for a specified zone of the plurality of zones;
c) receiving position information from a user in the scene, the user having a first body part and second body part;
d) recognizing a gesture from the first body part where the first body part has performed a recognizable gesture in the specified zone;
e) ignoring a gesture performed by the second body part where the second body part has not performed a recognizable gesture in the specified zone; and
f) performing an action associated with the gesture from the first body part recognized in said step d).

2. The method of claim 1, said step e) of ignoring a gesture performed by the second body part comprising the step of having a definition of body parts from which gestures are recognized in the specified zone, said second body part not being included in the definition.

3. The method of claim 2, said step of having a definition of body parts from which gestures are accepted comprising the step of a user indicating that the second body part is not included in the definition of body parts from which gestures are accepted.

4. The method of claim 1, said step e) of ignoring a gesture performed by the second body part comprising the step of not receiving position information from the second body part.

5. The method of claim 4, said step e) of not receiving position information from the second body part comprising the step of identifying and tracking body parts other than the second body part.

6. The method of claim 4, said step e) of not receiving position information from the second body part comprising the step of not tracking the second body part because the second body part in not in the specified zone.

7. The method of claim 1, the second body part being in a zone of the plurality of zones other than the specified zone when the gesture made with the second body part is ignored, and further comprising the step of recognizing and acting on the same gesture from the second body part when made in the specified zone of the plurality of zones.

8. The method of claim 1, further comprising the step of displaying an avatar on a screen associated with the computing environment, the avatar having a body part which is a virtual copy of the second body part, the user controlling movement of the virtual body part with movement of the user's first body part.

9. A method of recognizing and tracking body parts of a target, comprising:
a) obtaining body part proposals from a stateless body part proposal system receiving position information from a scene, wherein the stateless body part proposal system comprises body part locations without reference to prior frames of the scene;
b) obtaining body part proposals from a stateful body part proposal system, wherein the stateful body part proposal system comprises body part locations with reference to prior frames of the scene;
c) reconciling the candidate body parts into whole or partial targets by a resolution system;
d) segmenting a field of view of the scene into at least one zone smaller than the field of view of the scene; and
e) determining whether a body part reconciled into a whole or partial target in said step c) has performed a recognized gesture in the at least one zone.

10. The method of claim 9, said step a) of obtaining body part proposals from a stateless machine-learning body part proposal system comprising the step of obtaining body part proposals for a head and shoulders of the user by centroid probabilities.

11. The method of claim 9, said step b) of obtaining body part proposals from a stateful body part proposal system comprising the step of obtaining body part proposals for a head and shoulders of the user by at least one of magnetism and persistence from a past frame.

12. The method of claim 9, said step of reconciling the candidate body parts into whole or partial skeletons comprising running one or more scored tests which allow identification of the hypothesis that has the greatest support.

13. The method of claim 12, said step of performing one or more tests comprising the step of performing a test checking for pixel motion near the hand proposals to detect how fast the pixels in the vicinity of a hand proposal are moving.

14. The method of claim 9, said step b) comprising the step of identifying a first group of joints by the steps of:
f) identifying candidate head and shoulder proposals that correspond to real players;
g) evaluating hand proposals which potentially belong to each shoulder of each candidate in said step f); and
h) evaluating elbow proposals which connects hand proposals in said step g) with shoulder proposals in said step f).

15. The method of claim 14, said step h) comprising the step of trying a plurality of possible arm hypotheses, performing one or more tests to score the arm hypotheses, and using an arm hypothesis having a highest score as the identified positions of joints in the first group of joints.

16. The method of claim 12, wherein the step of performing one or more tests includes the step of performing a trace and saliency test where depth map samples inside a possible arm hypothesis and outside a possible arm hypothesis are evaluated against expected depth map values for the possible arm hypothesis and a score is produced.

17. A computer-readable storage medium capable of programming a processor to perform a method of recognizing and tracking body parts of a user having at least limited use of at least one immobilized body part, the method comprising:
a) receiving an indication from the user of the identity of the at least one immobilized body part;
b) identifying a first group of joints of the user, the joints not included within the at least one immobilized body part;
c) identifying positions of joints in the first group of joints; and
d) performing an action based on positions of the joints identified in said step c).

18. The computer-readable storage medium of claim 17, said step a) further comprising the step of receiving an indication from the user of whether the at least one immobilized body part is permanently or temporarily immobilized.

19. The computer-readable storage medium of claim 17, further comprising the steps of displaying an avatar on a screen associated with the computing environment, the avatar having a virtual body part which corresponds to an immobilized body part of the at least one immobilized body parts, and receiving an indication from the user of a substitute body part other than the immobilized body part to control the virtual body part of the onscreen avatar.

20. The computer-readable storage medium of claim 17, said step a) of receiving an indication from the user of the identity of the at least one immobilized body part comprising one of:
a1) receiving an indication that the user's legs are immobilized,
a2) receiving an indication that the user's arms are immobilized,
a3) receiving an indication that the user's right arm and right leg are immobilized, and
a4) receiving an indication that the user's left arm and left leg are immobilized.
